(19) United States
(12) Patent Application Publication
(10) Pub. No.: US 2024/0040412 A1
(43) Pub. Date: Feb. 1, 2024

(54) METHODS, APPARATUS, AND ARTICLES OF MANUFACTURE TO IMPROVE PERFORMANCE OF NETWORKS OPERATING IN MULTIPLE FREQUENCY BANDS

(71) Applicant: TEXAS INSTRUMENTS INCORPORATED, Dallas, TX (US)

(72) Inventors: Kumaran VIJAYASANKAR, Allen, TX (US); Arvind KANDHALU RAGHU, Frisco, TX (US); Jyothsna KUNDURU, Dallas, TX (US)

(21) Appl. No.: 18/482,775

(22) Filed: Oct. 6, 2023

Related U.S. Application Data
(63) Continuation-in-part of application No. 18/195,254, filed on May 9, 2023.
(60) Provisional application No. 63/340,771, filed on May 11, 2022.
(60) Provisional application No. 63/340,782, filed on May 11, 2022.
(60) Provisional application No. 63/340,759, filed on May 11, 2022.

(51) Int. Cl. H04W 24/08; H04W 16/14

(52) U.S. Cl. CPC H04W 24/08; H04W 16/14

(57) ABSTRACT

In some examples, a device includes receiver circuitry and processing circuitry coupled to the receiver circuitry. In examples, the processing circuitry is configured to transition, at a first time, from monitoring a first channel via the receiver circuitry to monitoring a second channel via the receiver circuitry, wherein the first channel is associated with a first communication protocol and the second channel is associated with a second communication protocol. In examples, the processing circuitry is also configured to transition, at a second time, from monitoring the second channel via the receiver circuitry to monitoring the first channel via the receiver circuitry responsive to not detecting communication on the second channel, wherein an amount of time between the first time and the second time is based on a detection time for the second communication protocol.

### CROSS-REFERENCE TO RELATED APPLICATION

This application is a continuation-in-part of U.S. patent application Ser. No. 18/195,254, filed May 9, 2023, which claims the benefit of and priority to U.S. Provisional Patent Application No. 63/340,771, filed May 11, 2022; U.S. Provisional Patent Application No. 63/340,782, filed May 11, 2022, and U.S. Provisional Patent Application No. 63/340,759, filed May 11, 2022, which Applications are hereby incorporated herein by reference in its entirety.

### TECHNICAL FIELD

This description relates generally to wireless communication and, more particularly, to methods, apparatus, and articles of manufacture to improve performance of networks operating in multiple frequency bands.

### BACKGROUND

Institute of Electrical and Electronics Engineers (IEEE) 802.15.4 is a technical standard that defines the operation of a low-rate wireless personal area network (LR-WPAN). IEEE 802.15.4 is the basis, for example, of the Zigbee®, Thread®, and Wi-SUN® specifications, each of which further extends the standard by developing the upper layers which are not defined in IEEE 802.15.4. Many deployments of IEEE 802.15.4 based technologies use an asynchronous non-beacon mode of personal area network (PAN) operation in the global 2.4 gigahertz (GHz) industrial, scientific and medical (ISM) radio frequency (RF) band. Zigbee® and Thread® are examples of popular mesh networking technologies based on this mode of operation. Additionally, PAN operation is also implemented in Internet of Things (IoT) networks.

### SUMMARY

In some examples, a device includes receiver circuitry and processing circuitry coupled to the receiver circuitry. In examples, the processing circuitry is configured to transition, at a first time, from monitoring a first channel via the receiver circuitry to monitoring a second channel via the receiver circuitry, wherein the first channel is associated with a first communication protocol and the second channel is associated with a second communication protocol. In examples, the processing circuitry is also configured to transition, at a second time, from monitoring the second channel via the receiver circuitry to monitoring the first channel via the receiver circuitry responsive to not detecting communication on the second channel, wherein an amount of time between the first time and the second time is based on a detection time for the second communication protocol.

In some examples, a method includes listening, via receiver circuitry, to a first portion of a frequency band for a first amount of time for communication via a first communication protocol. In some examples, the method also includes listening, via the receiver circuitry, to a second portion of the frequency band for a second amount of time, wherein the second amount of time has a duration that is based on a detection time of a second communication protocol, wherein the second communication protocol is different from the first communication protocol. In some examples, the method also includes responsive to not detecting communication on the second portion of the frequency band within the second amount of time, listening, via the receiver circuitry, to the first portion of the frequency band for the first amount of time.

### BRIEF DESCRIPTION OF THE DRAWINGS

FIG. 1 is a block diagram of an example network including devices capable of communicating in multiple frequency bands.

FIG. 2 is a block diagram of an example implementation of a parent device in the network of FIG. 1.

FIG. 3 is a block diagram of an example implementation of a child device in the network of FIG. 1.

FIG. 4 is a timing diagram illustrating example channel hopping in the network of FIG. 1 for example parent devices having different dwell times.

FIG. 5 is a timing diagram illustrating example channel hopping in the network of FIG. 1 for an example child device in a sleep mode of operation and an example parent device.

FIG. 6 is a flowchart representative of example machine-readable instructions and/or example operations that may be executed, instantiated, and/or performed using an example processing circuitry implementation of the parent device of FIG. 2 to perform channel hopping across multiple frequency bands.

FIG. 7 is a flowchart representative of example machine-readable instructions and/or example operations that may be executed, instantiated, and/or performed using an example processing circuitry implementation of the parent device of FIG. 2 to perform channel hopping in a base frequency band.

FIG. 8 is a flowchart representative of example machine-readable instructions and/or example operations that may be executed, instantiated, and/or performed using an example processing circuitry implementation of the child device of FIG. 3 to synchronize with an example parent device.

FIG. 9 is a flowchart representative of example machine-readable instructions and/or example operations that may be executed, instantiated, and/or performed using an example processing circuitry implementation of the child device of FIG. 3 to perform coordinated sampled listening with channel hopping.

FIG. 10 is a flowchart representative of example machine-readable instructions and/or example operations that may be executed, instantiated, and/or performed using an example processing circuitry implementation of the parent device of FIG. 2 to utilize an alternate frequency band to assist in parent selection for a child device.

FIG. 11 is a flowchart representative of example machine-readable instructions and/or example operations that may be executed, instantiated, and/or performed using an example processing circuitry implementation of the parent device of FIG. 2 to utilize an alternate frequency band to assist in parent selection for a child device.

FIG. 12 is a flowchart representative of example machine-readable instructions and/or example operations that may be executed, instantiated, and/or performed using an example processing circuitry implementation of the child device of FIG. 3 to select a parent device.

FIG. 13 is a block diagram of an example processing circuitry platform including processing circuitry structured to execute, instantiate, and/or perform the example machine-readable instructions and/or perform the example operations of FIGS. 6, 7, 10, and/or 11 to implement the parent device of FIG. 2.

FIG. 14 is a block diagram of an example processing circuitry platform including processing circuitry structured to execute, instantiate, and/or perform the example machine-readable instructions and/or perform the example operations of FIGS. 8, 9, and/or 12 to implement the child device of FIG. 3.

FIG. 15 is a block diagram of an example implementation of the processing circuitry of FIG. 13 and/or the processing circuitry of FIG. 14.

FIG. 16 is a block diagram of another example implementation of the processing circuitry of FIG. 13 and/or the processing circuitry of FIG. 14.

FIG. 17 is a block diagram of an example software/firmware/instructions distribution platform (e.g., one or more servers) to distribute software, instructions, and/or firmware (e.g., corresponding to the example machine-readable instructions of FIGS. 6, 7, 8, 9, 10, 11, 12, and/or 20) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 18 is a timing diagram illustrating example time multiplexing of receiver circuitry of a child device.

FIG. 19 is a timing diagram illustrating example time multiplexing of receiver circuitry of a child device.

FIG. 20 is a timing diagram illustrating example time multiplexing of receiver circuitry of a child device.

FIG. 21 is a flowchart representative of example machine-readable instructions and/or example operations that may be executed, instantiated, and/or performed using an example processing circuitry implementation of a child device of FIG. 3 to perform time multiplexed packet detection.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Operating in the sub-1 GHz RF spectrum (e.g., a radio frequency lower than 1 GHz) as well as the widely-utilized 2.4 GHz spectrum is desirable. For example, operating in the sub-1 GHz spectrum and the 2.4 GHz spectrum enables longer links (e.g., long range propagation) within the network, more robust links through mediums like concrete, and will avoid the congested 2.4 GHz band. Additionally, maintaining existing operation within the 2.4 GHz RF spectrum is desirable. For example, operating in the 2.4 GHz band maintains global ISM operation mode and leverages the ubiquity of 2.4 GHz solutions. Additional example details of operating in the sub-1 GHz and 2.4 GHz spectrums can be found in commonly assigned U.S. Patent Application Publication No. 2023/0052555, entitled “Devices and Methods for Asynchronous and Synchronous Wireless Communications Utilizing a Single Radio,” filed on Aug. 10, 2022, which is incorporated herein by reference in its entirety.

However, operation of a single network across two RF bands with a single radio presents challenges in most IEEE 802.15.4 implementations. One challenge presented by sub-1 GHz operation is the onus of duty cycling mandated (e.g., channel hopping) by certain regions' RF regulatory bodies (e.g., the Federal Communications Commission (FCC)). For example, if a device is operating with a bandwidth less than a threshold bandwidth (e.g., less than a 400 kHz bandwidth) and a transmitter power above a threshold power (e.g., more than 30 dBm), then the FCC requires the device to channel hop at least 50 channels. An example frequency band may be divided into one or more channels where a channel refers to a frequency range within the frequency band. For example, in the 2.4 GHz band, a first channel may exist for a frequency range of 2.41 to 2.45 MHz and a second channel may exist for a frequency range of 2.48 to 2.50 MHz. Existing channel hopping techniques are limited to a single frequency range. Existing channel hopping techniques also require all coordinators (e.g., routers, gateways, etc.) that are part of a network to support the same frequency bands. Furthermore, existing channel hopping techniques place a high computational burden on coordinators to synchronize with neighboring devices. For example, existing channel hopping techniques require coordinators to maintain synchronization information about all neighboring devices, which can exceed 50 devices in real-world networks.

Additionally, existing channel hopping techniques complicate device operation by requiring all coordinators in a network to periodically transmit data on all channels so that child devices in the network can select a parent device that potentially has a stronger connection to one or more of the child devices. Furthermore, existing channel hopping techniques do not support coordinated sampled listening (CSL). CSL is a feature of IEEE 802.15.4 that allows for low power child devices to shift from a sleep mode of operation to a wake mode of operation at specific periodic instances synchronized with a parent device. For example, a parent device can schedule data exchanges with a child device at specific periodic instances. However, existing channel hopping techniques do not support this feature of IEEE 802.15.4. Additionally, existing channel hopping techniques do not support discovery of other devices operating in different frequency bands. For example, a child device operating according to existing CSL techniques cannot discover other devices that may be operating in a different frequency band than the child device.

Examples described herein enable channel hopping in the sub-1 GHz band (e.g., to enable range extension links) while reducing (e.g., minimizing) changes to operation in the 2.4 GHz band (e.g., to enable reuse of the existing software stack for 2.4 GHz operation). For example, methods, apparatus, and articles of manufacture described herein handle multiple frequency bands as part of the channel hopping sequence. Additionally, examples described herein reduce the computational burden of synchronizing devices by synchronizing channel hopping in sub-networks (e.g., without synchronizing a device will all neighboring devices). Furthermore, examples described herein enable frequency hopping with CSL. Examples described herein also utilize overlapping channel hopping sequences between parent devices to aid child devices in selection of parent devices that potentially have stronger connections to the child devices. Additionally, methods, apparatus, and articles of manufacture described herein utilize an alternate frequency band supported by parent devices to enable selection of parent devices that potentially have stronger connections to child devices.

Examples described herein also enable time multiplexing of a radio between multiple communication protocols, such as first and second communication protocols. In some examples, the first communication protocol may be a Bluetooth® protocol, such as Bluetooth® Low Energy (BLE) and the second communication protocol may be a Zigbee® protocol. For example, the first and second communication protocols may use a common frequency band for operation, such as the 2.4 GHz, or ISM, band. Each of the first and second communication protocols may operate in separate channels (at least some of which may have overlapping frequencies between the first and second communication protocols), have different physical layer frame formats, and the like.

In some embodiments, the first and second communication protocols may share a single physical radio. For example, communication according to the first and second communication protocols may be received and/or transmitted via a same, single physical radio. In such examples, there may be limitations placed on communication via one, or both, of the first or second communication protocols based on the shared radio. For example, while listening via the radio for communication according to one of the protocols, communication via the other protocol may be missed. In some systems, a radio is tuned to listen for communication on particular channels in a time divided manner. However, in such systems, some data communicated on a channel according to the protocol for which the radio was not listening at that specific time may be lost. In some examples the first and second communication protocols are synchronous protocols. For example, communication packets transmitted according to the first or second communication protocols may arrive or be received according to periodic or known time intervals. In this way, it may be possible to listen for communication via one protocol in a period of time in which it is known that a second protocol will not be transmitting, and vice versa.

At least some of the time multiplexing examples described herein reduce data loss as described above, improving network efficiency and user experience from a perspective of a receiver or receiving device communicating in a network. In some approaches, a multi-protocol system having a radio shared between first and second communication protocols may tune the radio to listen to channels corresponding to the first and second communication protocols for amounts of time suitable for performing basic network operations as defined in the respective protocols, for an amount of time approximately equal to a frame duration according to the respective protocols, a duration of time for receiving and processing a frame, or the like.

In examples of this description, the time multiplexing may protect, or increase an amount of time for which the radio listens to channels associated with the first communication protocol while listening to channels associated with the second communication protocol a reduced amount of time determined to have a probability of detecting communication according to the second communication protocol that is greater than a threshold probability. Such a time multiplexing approach may decrease a probability that communication according to the first communication protocol or the second communication protocol will be missed, or lost, by the receiving device resulting from the receiving device sharing a radio between the first and second communication protocols.

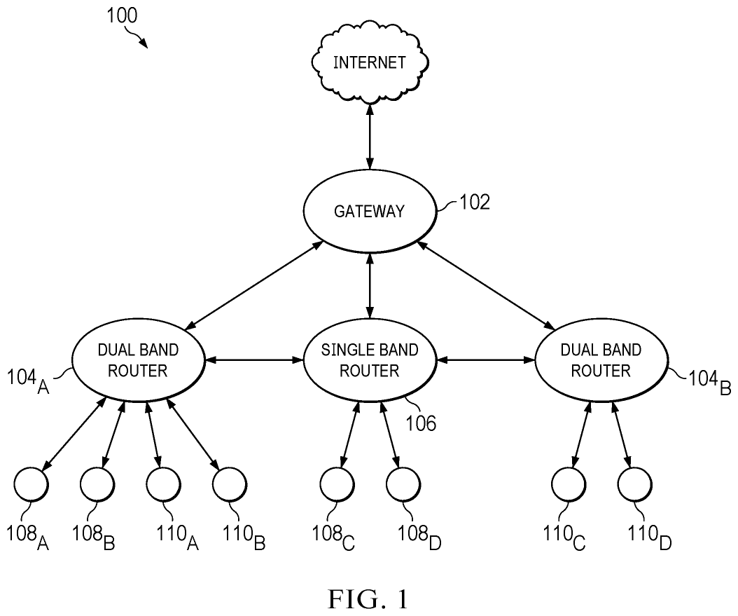

FIG. 1 is a block diagram of an example network 100 including devices capable of communicating in multiple frequency bands. For example, the network 100 includes devices operating in the sub-1 GHz frequency band and devices operating in the 2.4 GHz frequency band. In the example of FIG. 1, the network 100 includes an example gateway 102, a first example dual band router 104_{A}, a second example dual band router 104_{B}, an example single band router 106, a first example endpoint device 108_{A}, a second example endpoint device 108_{B}, a third example endpoint device 108c, a fourth example endpoint device 108_{D}, a fifth example endpoint device 110_{A}, a sixth example endpoint device 110_{B}, a seventh example endpoint device 110_{C}, and an eighth example endpoint device 110_{D}.

In the illustrated example of FIG. 1, the network 100 includes one or more parent devices and one or more child devices. An example parent device is a device that directs data packets between devices and/or networks. For example, parent devices include gateways and routers. An example child device is a device that is synchronized with a parent device. For example, child devices include endpoint devices and interior routers (e.g., routers synchronized with a gateway).

In the illustrated example of FIG. 1, gateway 102 is coupled to the Internet, the first dual band router 104_{A}, the second dual band router 104_{B}, and the single band router 106. In the example of FIG. 1, the gateway 102 includes one or more protocol translators, one or more impedance matchers, one or more rate converters, one or more fault isolators, and/or one or more signal translators. In the example of FIG. 1, the gateway 102 operates in a single frequency band. For example, the gateway 102 operates in the 2.4 GHz frequency band. In the example of FIG. 1, the gateway 102 directs data packets between the Internet, the first dual band router 104_{A}, the second dual band router 104_{B}, and the single band router 106. For example, the gateway 102 allows data packets to flow from the network 100 to the Internet. As such, in the example of FIG. 1, the gateway 102 operates as a parent device to the first dual band router 104_{A}, the single band router 106, and the second dual band router 104_{B}.

In the illustrated example of FIG. 1, the first dual band router 104_{A} is coupled to the gateway 102, the single band router 106, the first endpoint device 108_{A}, the second endpoint device 108_{B}, the fifth endpoint device 110_{A}, and the sixth endpoint device 110_{B}. In the example of FIG. 1, the first dual band router 104_{A} includes software and/or hardware circuitry. For example, the first dual band router 104_{A} includes routing software executing on a central processor unit (CPU). Additionally or alternatively, the first dual band router 104_{A} includes one or more Application Specific Integrated Circuits (ASICs). In the example of FIG. 1, the first dual band router 104_{A} operates in multiple frequency bands. For example, the first dual band router 104_{A} is capable of operating in the sub-1 GHz frequency band and the 2.4 GHz frequency band. In the example of FIG. 1, the first dual band router 104_{A} utilizes a base frequency band as a frequency band in which the first dual band router 104_{A} operates for a synchronous mode of operation. For example, the first dual band router 104_{A} utilizes the sub-1 GHz frequency band a base frequency band. In the example synchronous mode of operation, the first dual band router 104_{A} and child devices of the first dual band router 104_{A} synchronize channel hopping. Additionally, in the example of FIG. 1, the first dual band router 104_{A} utilizes an alternate frequency band as a frequency band in which the first dual band router 104_{A} operates for an asynchronous mode of operation. For example, the first dual band router 104_{A} utilizes the 2.4 GHz frequency band as an alternate frequency band. In the example asynchronous mode of operation, the first dual band router 104_{A} and child device of the first dual band router 104_{A} may not synchronize channel hopping.

In the illustrated example of FIG. 1, the first dual band router 104_{A} directs data packets between the gateway 102, the single band router 106, and ones of the first endpoint device 108_{A}, the second endpoint device 108_{B}, the fifth endpoint device 110_{A}, and the sixth endpoint device 110_{B}. For example, the first dual band router 104_{A} utilizes information included in a routing table and/or routing policy to direct packets between the gateway 102, the single band router 106, and ones of the first endpoint device 108_{A}, the second endpoint device 108_{B}, the fifth endpoint device 110_{A}, and the sixth endpoint device 110_{B}. Thus, the first dual band router 104_{A} connects the first endpoint device 108_{A}, the second endpoint device 108_{B}, the fifth endpoint device 110_{A}, and the sixth endpoint device 110_{B} to other devices in the network 100. In some examples, the first dual band router 104_{A} utilizes the alternate frequency band supported by the first dual band router 104_{A} and the second dual band router 104_{B} to establish a communication session with the second dual band router 104_{B}. In the example of FIG. 1, the first dual band router 104_{A} operates as a parent device with respect to the first endpoint device 108_{A}, the second endpoint device 108_{B}, the fifth endpoint device 110_{A}, and the sixth endpoint device 110_{B}.

In the illustrated example of FIG. 1, the second dual band router 104_{B} is coupled to the gateway 102, the single band router 106, the seventh endpoint device 110_{C}, and the eighth endpoint device 110_{D}. In the example of FIG. 1, the second dual band router 104_{B} includes software and/or hardware circuitry. For example, the second dual band router 104_{B} includes routing software executing on a CPU. Additionally or alternatively, the second dual band router 104_{B} includes one or more ASICs. In the example of FIG. 1, the second dual band router 104_{B} operates in multiple frequency bands. For example, the second dual band router 104_{B} is capable of operating in the sub-1 GHz frequency band and the 2.4 GHz frequency band. In the example of FIG. 1, the second dual band router 104_{B} utilizes a base frequency band as a frequency band in which the second dual band router 104_{B} operates for a synchronous mode of operation. For example, the second dual band router 104_{B} utilizes the sub-1 GHz frequency band a base frequency band. In the example synchronous mode of operation, the second dual band router 104_{B} and child devices of the second dual band router 104_{B} synchronize channel hopping. Additionally, in the example of FIG. 1, the second dual band router 104_{B} utilizes an alternate frequency band as a frequency band in which the second dual band router 104_{B} operates for an asynchronous mode of operation. For example, the second dual band router 104_{B} utilizes the 2.4 GHz frequency band as an alternate frequency band. In the example asynchronous mode of operation, the second dual band router 104_{B} and child devices of the second dual band router 104_{B} may not synchronize channel hopping.

In the illustrated example of FIG. 1, the second dual band router 104_{B} directs data packets between the gateway 102, the single band router 106, and ones of the seventh endpoint device 110_{C} and the eighth endpoint device 110_{D}. For example, the second dual band router 104_{B} utilizes information included in a routing table and/or routing policy to direct packets between the gateway 102, the single band router 106, and ones of the seventh endpoint device 110_{C} and the eighth endpoint device 110_{D}. Thus, the second dual band router 104_{B} connects the seventh endpoint device 110_{C} and the eighth endpoint device 110_{D} to other devices in the network 100. In some examples, the second dual band router 104_{B} utilizes the alternate frequency band supported by the second dual band router 104_{B} and the first dual band router 104_{A} to establish a communication session with the first dual band router 104_{A}. In the example of FIG. 1, the second dual band router 104_{B} operates as a parent device with respect to the seventh endpoint device 110_{C} and the eighth endpoint device 110_{D}.

In the illustrated example of FIG. 1, the single band router 106 is coupled to the gateway 102, the first dual band router 104_{A}, the second dual band router 104_{B}, the third endpoint device 108c, and the fourth endpoint device 108_{D}. In the example of FIG. 1, the single band router 106 includes software and/or hardware circuitry. For example, the single band router 106 includes routing software executing on a CPU. Additionally or alternatively, the single band router 106 includes one or more ASICs. In the example of FIG. 1, the single band router 106 operates in a single frequency band. For example, the single band router 106 operates in the 2.4 GHz frequency band. In the example of FIG. 1, the single band router 106 directs data packets between the gateway 102, the first dual band router 104_{A}, the second dual band router 104_{B}, and ones of the third endpoint device 108c and the fourth endpoint device 108_{D}. For example, the single band router 106 utilizes information included in a routing table and/or routing policy to direct packets between the gateway 102, the first dual band router 104_{A}, the second dual band router 104_{B}, and ones of the third endpoint device 108c and the fourth endpoint device 108_{D}. Thus, the single band router 106 connects the third endpoint device 108c and the fourth endpoint device 108_{D} to other devices in the network 100. In the example of FIG. 1, the single band router 106 operates as a parent device with respect to the third endpoint device 108c and the fourth endpoint device 108_{D}.

In the illustrated example of FIG. 1, the first endpoint device 108_{A} and the second endpoint device 108E are coupled to the first dual band router 104_{A}. Additionally, the third endpoint device 108c and the fourth endpoint device 108_{D} are coupled to the single band router 106. In the example of FIG. 1, the first endpoint device 108_{A}, the second endpoint device 108_{B}, the third endpoint device 108_{C}, and the fourth endpoint device 108_{D} operate in the 2.4 GHz frequency band. In the example of FIG. 1, one or more of the first endpoint device 108_{A}, the second endpoint device 108_{B}, the third endpoint device 108_{C}, and/or the fourth endpoint device 108_{D} may be implemented by a smart speaker, a smart plug, a smart tap (e.g., a smart water tap), a contact sensor (e.g., to detect whether a window or door is open), a smart light, among others.

In the illustrated example of FIG. 1, the fifth endpoint device 110_{A} and the sixth endpoint device 110_{B} are coupled to the first dual band router 104_{A}. Additionally, the seventh endpoint device 110_{C} and the eighth endpoint device 110_{D} are coupled to the second dual band router 104_{B}. In the example of FIG. 1, the fifth endpoint device 110_{A}, the sixth endpoint device 110_{B}, the seventh endpoint device 110_{C}, and the eighth endpoint device 110_{D} operate in the sub-1 GHz frequency band. In the example of FIG. 1, one or more of the fifth endpoint device 110_{A}, the sixth endpoint device 110_{B}, the seventh endpoint device 110_{C}, and/or the eighth endpoint device 110_{D} may be implemented by a smart speaker, a smart plug, a smart tap (e.g., a smart water tap), a contact sensor (e.g., to detect whether a window or door is open), a smart light, among others.

In the illustrated example of FIG. 1, when joining the network 100, a child device transmits a discovery request to one or more parent devices (e.g., the first dual band router 104_{A}, the second dual band router 104_{B}, and the single band router 106) in the network 100. In response to receiving a discovery request, a parent device transmits a response including synchronization information to be used by a candidate child device to synchronize with the parent device. Accordingly, in response to a discovery request, a child device attempting to join the network 100 may receive multiple responses from candidate parent devices. After a child device is synchronized with a parent device, the parent device transmits a timing element (e.g., a timing packet) to the child device with each data packet and/or acknowledged packet sent to the child device. An example timing element includes information identifying the elapsed time since the parent device last hopped channels.

In the illustrated example of FIG. 1, channel hopping in the network 100 is limited to sub-networks of the network 100. For example, child devices operating in the sub-1 GHz frequency band synchronize to the channel hopping schedule of the parent devices to which the child devices are synchronized. As such, child devices store synchronization information for parent devices to which the child devices are synchronized. Additionally, parent devices do not need to, but may, store synchronization information for neighboring peer devices and/or child devices. In the example of FIG. 1, the fifth endpoint device 110_{A} and the sixth endpoint device 110E synchronize to the channel hopping schedule of the first dual band router 104_{A}. Additionally, in the example of FIG. 1, the seventh endpoint device 110_{C} and the eighth endpoint device 110_{D} synchronize to the channel hopping schedule of the second dual band router 104_{B}. In some examples, child devices also store synchronization information for the one or more candidate parent devices with which the child device did not synchronize. As such, the child device may be able to synchronize with the other candidate parent devices at a different time.

In the illustrated example of FIG. 1, although all child devices synchronized to a given sub-1 GHz capable parent device and the sub-1 GHz capable parent device channel hop on a synchronized schedule, each such group of devices channel hop on different schedules enabling frequency diversity across sub-networks of the network 100. For example, in the example of FIG. 1, the first dual band router 104_{A} and the second dual band router 104_{B} operate with different channel hopping sequences. For example, the sub-network of the first dual band router 104_{A} and the second dual band router 104_{B} that are operating on the sub-1 GHz frequency band do not interfere with one another. As such, frequency diversity in the network 100 is improved.

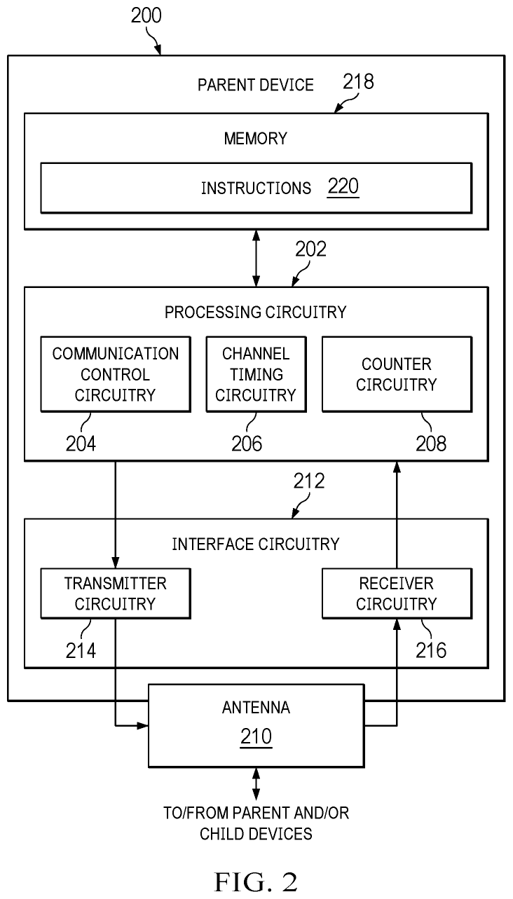

FIG. 2 is a block diagram of an example implementation of a parent device 200 in the network 100 of FIG. 1. For example, one or more of the first dual band router 104_{A} or the second dual band router 104_{B} may be implemented by the parent device 200. In the example of FIG. 2, the parent device 200 includes example processing circuitry 202. The example processing circuitry 202 of FIG. 2 includes example communication control circuitry 204, example channel timing circuitry 206, and example counter circuitry 208. The example parent device 200 of FIG. 2 also includes an antenna 210 and example interface circuitry 212. The example interface circuitry 212 includes example transmitter circuitry 214 and example receiver circuitry 216. Additionally, in the example of FIG. 2, the parent device 200 includes example memory 218. The example memory 218 includes example instructions 220.

In the example of FIG. 2, the parent device 200 may be instantiated (e.g., creating an instance of, bring into being for any length of time, materialize, implement, etc.) by processing circuitry such as a Central Processor Unit (CPU) executing first instructions. Additionally or alternatively, the parent device 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

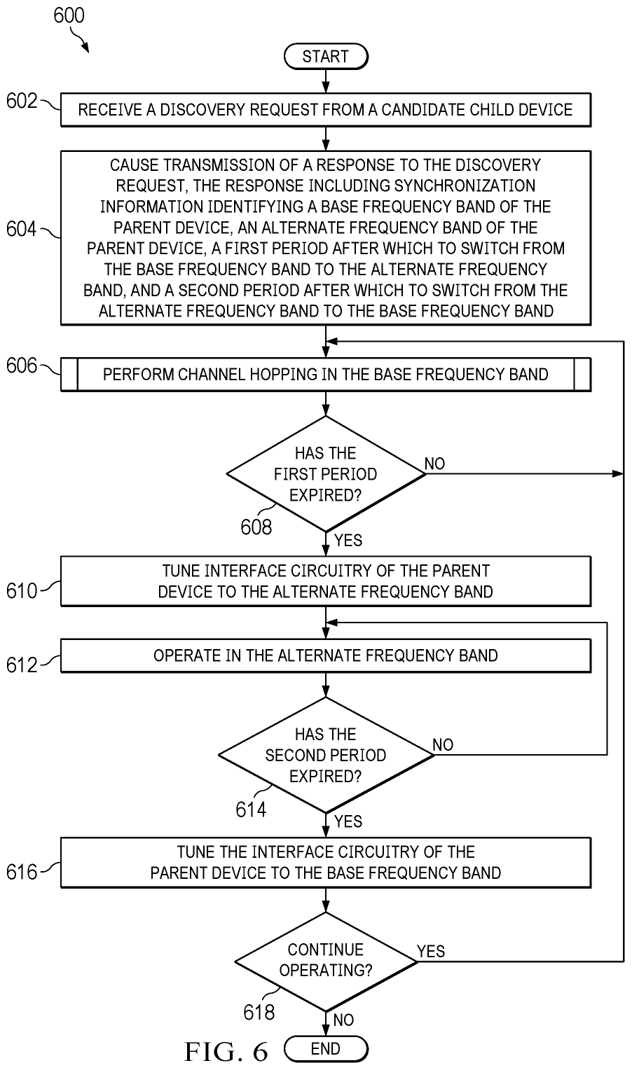

In the illustrated example of FIG. 2, the processing circuitry 202 is coupled to the interface circuitry 212 and the memory 218. For example, the processing circuitry 202 is coupled to the transmitter circuitry 214, the receiver circuitry 216, and the memory 218. In the example of FIG. 2, the processing circuitry 202 may be implemented by one or more CPUs, one or more ASIC, and/or one or more FPGAs. In some examples, the processing circuitry 202 is instantiated by processing circuitry executing parent instructions and/or configured to perform operations such as those represented by the flowchart(s) of FIGS. 6, 7, 10, and/or 11.

In the illustrated example of FIG. 2, the communication control circuitry 204 may be implemented by one or more CPUs, one or more ASICs, and/or one or more FPGAs. In the example of FIG. 2, the communication control circuitry 204 monitors the network 100 for one or more discovery requests from candidate child devices. For example, before a candidate child device synchronizes with the parent device 200, the candidate child device transmits a discovery request to the parent device 200. As described below, the discovery request identifies a specific channel to which interface circuitry of the candidate child device will be tuned for a predetermined period of time. In the example of FIG. 2, based on receiving a discovery request, the communication control circuitry 204 causes, via the transmitter circuitry 214, transmission of a response to the discovery request on the channel specified in the discovery request.

In the illustrated example of FIG. 2, a response to a discovery request includes synchronization information. Example synchronization information includes data identifying a number of channels to which the communication control circuitry 204 is to tune the interface circuitry 212, a pseudo-random sequence according to which the communication control circuitry 204 is to hop between channels, two or more dwell times (e.g., 50 milliseconds (ms), 250 ms, etc.) that the channel timing circuitry 206 is to use to program the counter circuitry 208, and a period (e.g., a DWELL_TIME_SWITCH parameter) after which the channel timing circuitry 206 is to alternate dwell times. Additionally, example synchronization information includes data identifying a base frequency band (e.g., the sub-1 GHz band) of the parent device 200, an alternate frequency band (e.g., the 2.4 GHz band) of the parent device 200, a period (e.g., a FREQ_SWITCH_CHANNEL PARAMETER) after which the communication control circuitry 204 is to switch from the base frequency band to the alternate frequency band, and a period (e.g., a ALT_FREQ_SLOT_RANGE) after which the communication control circuitry 204 is to switch from the alternate frequency band to the base frequency band. Example synchronization information may be formatted as illustrated in Table 1 below.

TABLE 1

| | |
|---|---|
| Number of Channels | 9 |
| Pseudo-Random Sequence | 9, 6, 2, 3, 7, |
| | 1, 8, 5, 4 |
| DWELL_TIME_1 (ms) | 50 |
| DWELL_TIME_2 (ms) | 250 |
| DWELL_TIME_SWITCH (slots) | 50 |
| Base Frequency Band | sub-1 GHz |
| Alternate Frequency Band | 2.4 |
| FREQUENCY_SWITCH_CHANNEL_PARAMETER | 50 |
| (slots) | |
| ALT_FREQ_SLOT_RANGE (slots) | 10 |

In the illustrated example of FIG. 2, the FREQUENCY_SWITCH_CHANNEL_PARAMETER and the ALT_FREQ_SLOT_RANGE parameters are measured in slots. In examples described herein, a slot represents a period to be dedicated to a channel. For example, a slot is equal in duration to the dwell time. By including the FREQUENCY_SWITCH_CHANNEL_PARAMETER and the ALT_FREQ_SLOT_RANGE parameter in the synchronization information, the communication control circuitry 204 enables child devices synchronized with the parent device 200 to follow a channel hopping sequence that spans multiple frequency bands (e.g., both the sub-1 GHz frequency band and the 2.4 GHz frequency band).

In the illustrated example of FIG. 2, the example synchronization information of Table 1 indicates to child devices that every 50th slot, the parent device 200 will switch the interface circuitry 212 from being tuned to the base frequency band to being tuned to the alternate frequency band and remain in the alternate frequency band for 10 slots. In the example of Table 1, the base frequency band is the sub-1 GHz frequency band, which is utilized for the synchronous mode of operation, and the alternate frequency band is the 2.4 GHz frequency band, which is utilized for the asynchronous mode of operation. Example sub-1 GHz frequency bands include the 915 megahertz (MHz) frequency band (which may be applicable in regions governed by the FCC), the 868 MHz frequency band (which may be applicable in regions governed by regulations subscribing to standards provided by the European Telecommunications Standards Institute (ETSI)), and the 470 MHz frequency band (which may be applicable in regions governed by the Ministry of Industry and Information Technology of China). Additionally, the example synchronization information of Table 1 indicates to child devices that at the end of the 10 slots (e.g., the end of the ALT_FREQ_SLOT_RANGE), the parent device 200 will switch the interface circuitry 212 from being tuned to the 2.4 GHz frequency band to being tuned to the sub-1 GHz frequency band. In the example of FIG. 2, when the communication control circuitry 204 selects a channel (e.g., being in the sub-1 GHz frequency band or the 2.4 GHz frequency band), the communication control circuitry 204 will follow the hopping sequence on respective channels as though no disruption occurred. For example, in the example synchronization information of Table 1, slot number 65 would result with same channel as per the chosen channel hopping sequence irrespective of the whether the switch to the 2.4 GHz frequency band happened at slot 50 or not.

In the illustrated example of FIG. 2, the pseudo-random sequence identified in the synchronization information identifies N+M channels where N represents the number of slots to be dedicated to channels in the sub-1 GHz frequency band and M represents the number of slots to be dedicated to channels in the 2.4 GHz frequency band. Thus, channel hopping with N+M slots indicates that there will be M slots dedicated to the 2.4 GHz frequency band and there will be (N-Ad) slots dedicated to the sub-1 GHz frequency band. As described above, when the communication control circuitry 204 tunes the interface circuitry 212 to a channel in the sub-1 GHz frequency band, the communication control circuitry 204 keeps the interface circuitry 212 operating in the channel in the sub-1 GHz frequency band and channel hops to another channel in the sub-1 GHz frequency band after the dwell time expires. Additionally, in the example of FIG. 2, when the communication control circuitry 204 tunes the interface circuitry 212 to a channel in the 2.4 GHz frequency band, the communication control circuitry 204 does not follow a channel hopping sequence. Instead, in the example of FIG. 2, the communication control circuitry 204 causes the interface circuitry 212 to remain tuned to a single channel for the number of slots specified by the ALT_FREQ_SLOT_RANGE parameter. For example, channel hopping may not be mandated by certain regions' RF regulatory bodies when a device is operating in the 2.4 GHz frequency band. As such, when the parent device 200 is operating in the 2.4 GHz frequency band, the parent device 200 is considered to be operating in the asynchronous mode of operation. In additional or alternative examples, the communication control circuitry 204 performs channel hopping the in 2.4 GHz frequency band.

In the illustrated example of FIG. 2, after a child device synchronizes with the parent device 200 (e.g., using the synchronization information), the communication control circuitry 204 and the channel timing circuitry 206 perform channel hopping in the base frequency band of the parent device 200. In the example of FIG. 2, according to the synchronization information, the communication control circuitry 204 tunes the interface circuitry 212 to a channel and operates in the channel for a dwell time. For example, based on the pseudo-random sequence identified in the synchronization information, the communication control circuitry 204 computes the channel to which the interface circuitry 212 is to be tuned. Additionally, for example, the communication control circuitry 204 communicates (e.g., performs data exchanges) with child devices in the channel for a dwell time. In the example of FIG. 2, based on a dwell time expiring, the communication control circuitry 204 determines whether a data exchange in the first channel has expired. For example, for a child device utilizing CSL, if the child device and the parent device 200 are exchanging data when the dwell time expires, then the communication control circuitry 204 maintains the current tuning of the interface circuitry 212 until the data exchange is complete (e.g., until the communication control circuitry 204 receives an acknowledgement packet from and/or transmits an acknowledgement packet to the child device).

In the illustrated example of FIG. 2, the parent device 200 may cooperate with other parent devices in the network 100 to aid a child device in selecting a parent device that has a stronger connection with the child device. For example, if a child device is synchronized with the parent device 200, there may be a candidate parent device with stronger connectivity to the child device than the parent device 200. As such, the parent device 200 may cooperate with the candidate parent device to notify child device of the existence of the candidate parent device. Likewise, the parent device 200 may receive communications from other parent devices indicating candidate child devices with which the parent device 200 may have a stronger connection. In some examples, the communication control circuitry 204 is instantiated by processing circuitry executing communication control instructions and/or configured to perform operations such as those represented by the flowchart(s) of FIGS. 6, 7, 10, and/or 11.

In the illustrated example of FIG. 2, the channel timing circuitry 206 may be implemented by one or more CPUs, one or more ASICs, and/or one or more FPGAs. In the example of FIG. 2, the channel timing circuitry 206 controls the counter circuitry 208. For example, the channel timing circuitry 206 sets one or more counters of the counter circuitry 208 to track a dwell time of the parent device 200. For example, the channel timing circuitry 206 sets one or more counters of the counter circuitry 208 to count down from the dwell time identified in the synchronization information. Additionally or alternatively, the channel timing circuitry 206 sets one or more counters of the counter circuitry 208 to count up to the dwell time identified in the synchronization information. In the example of FIG. 2, the channel timing circuitry 206 determines whether the one or more dwell times have expired. For example, the channel timing circuitry 206 determines whether the one or more counters have counted down from the predefined value. Additionally or alternatively, the channel timing circuitry 206 determines whether the one or more counters have counted up to the predefined value.

In the illustrated example of FIG. 2, the channel timing circuitry 206 sets one or more counters of the counter circuitry 208 to track the number of slots utilized for each dwell time of the parent device 200. For example, the channel timing circuitry 206 sets one or more counters of the counter circuitry 208 to count down from the DWELL_TIME_SWITCH parameter identified in the synchronization information. Additionally or alternatively, the channel timing circuitry 206 sets one or more counters of the counter circuitry 208 to count up to the DWELL_TIME_SWITCH parameter identified in the synchronization information. In the example of FIG. 2, the channel timing circuitry 206 determines whether the DWELL_TIME_SWITCH period has expired. For example, the channel timing circuitry 206 determines whether the one or more counters have counted down from the predefined value. Additionally or alternatively, the channel timing circuitry 206 determines whether the one or more counters have counted up to the predefined value. Based on the channel timing circuitry 206 determining that the DWELL_TIME_SWITCH period has expired, the channel timing circuitry 206 utilizes a second dwell time. For example, the channel timing circuitry 206 sets one or more counters of the counter circuitry 208 to track the second dwell time. In this manner, the channel timing circuitry 206 advantageously enables child devices to select parent devices with which the child devices may have a stronger connection.

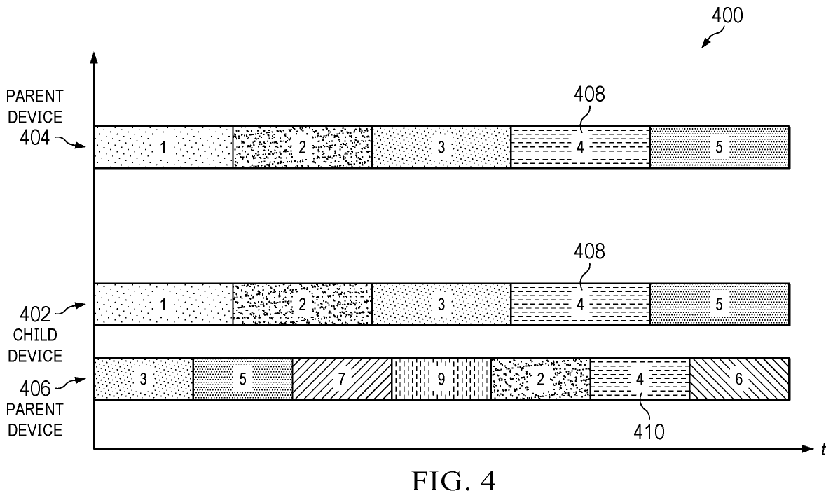

For example, once a child device is synchronized to the parent device 200, it may be advantageous for the child device to switch to a different parent device with which the child device has a stronger connection, if one such parent device is available. If the entire network operates on a single channel (e.g., does not implement channel hopping), then the child device could detect the different parent device. However, when the network implements channel hopping (e.g., the network 100), different parent devices could be hopping on different channels. As such, without adjustment, existing channel hopping techniques have a low probability of different parent devices transmitting on the same channel as the parent device to which a child device is synchronized. Advantageously, by utilizing different dwell times in the channel hopping sequence, the channel timing circuitry 206 increases the probability of a child device detecting a different parent device with which the child device has a stronger connection. For example, FIG. 4 illustrates an example where different parent devices utilize different dwell times. As described below, utilizing different dwell times across parent devices will increase the probability of two independent parent devices hopping on different sequences to have a common, overlapping, channel. In some examples, the channel timing circuitry 206 is instantiated by processing circuitry executing channel timing instructions and/or configured to perform operations such as those represented by the flowchart(s) of FIGS. 6 and/or 7.

In the illustrated example of FIG. 2, the counter circuitry 208 may be implemented by one or more CPUs, one or more ASICs, and/or one or more FPGAs. In the example of FIG. 2, the counter circuitry 208 includes one or more counters to track one or more dwell times, a period (in terms of slots) after which the parent device 200 is to switch the interface circuitry 212 from a base frequency band (e.g., the sub-1 GHz frequency band) to an alternate frequency band (e.g., the 2.4 GHz frequency band), a period (in terms of slots) after which the parent device 200 is to switch the interface circuitry 212 from the alternate frequency band to the base frequency band, and/or a period (in terms of slots) after which the channel timing circuitry 206 is to alternate dwell times. In some examples, the counter circuitry 208 is instantiated by processing circuitry executing counter instructions and/or configured to perform operations.

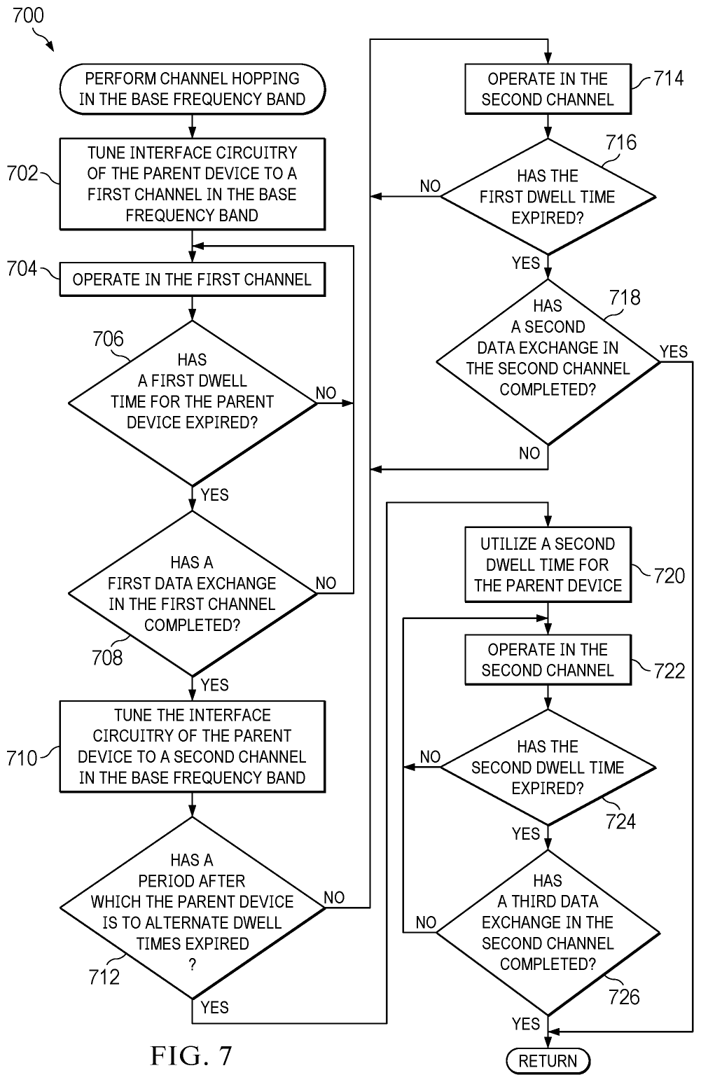

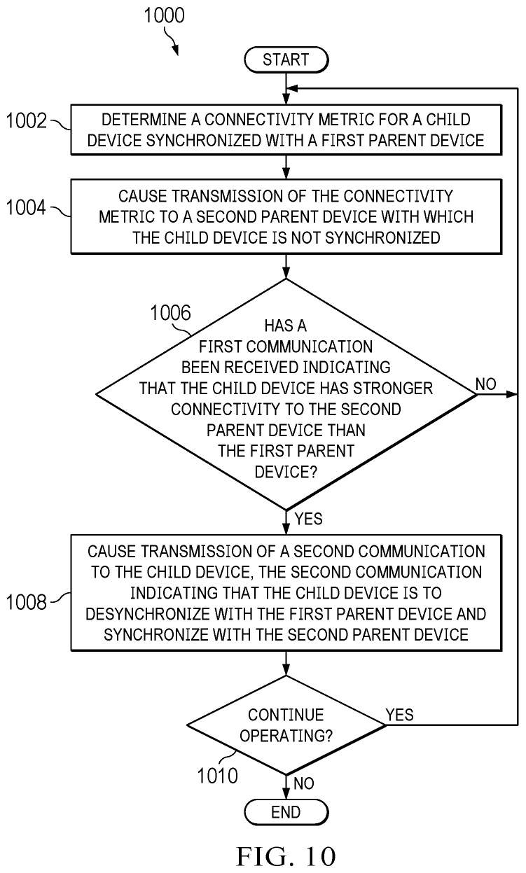

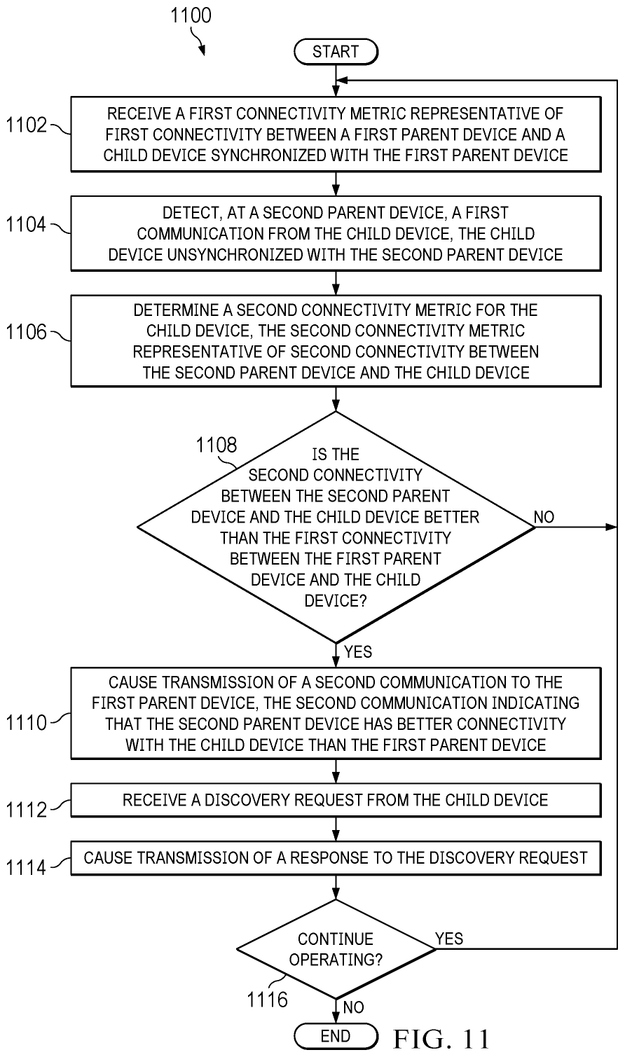

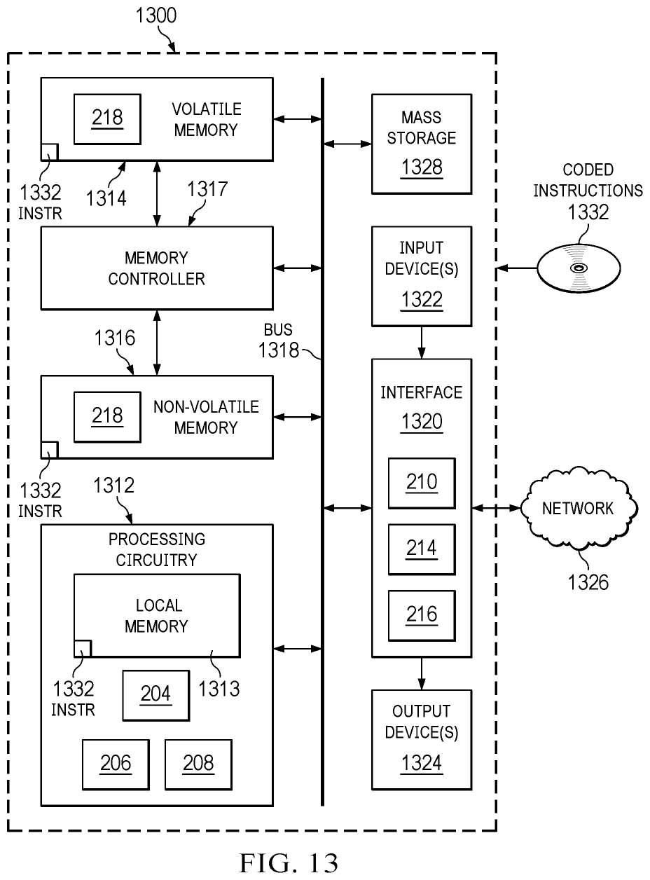

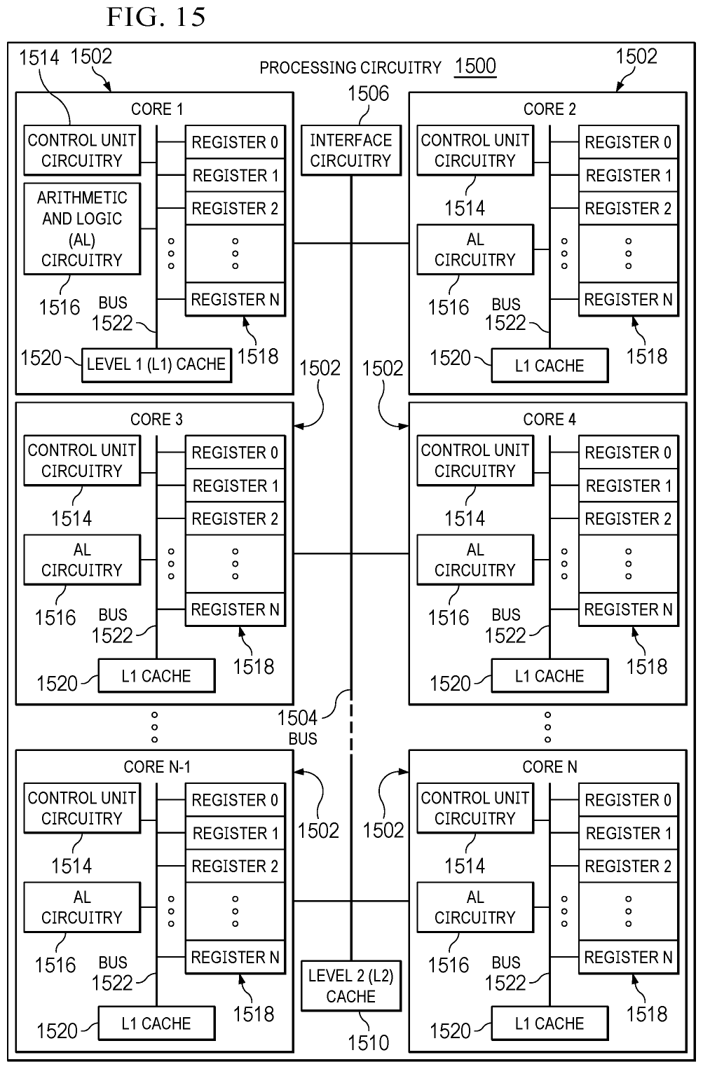

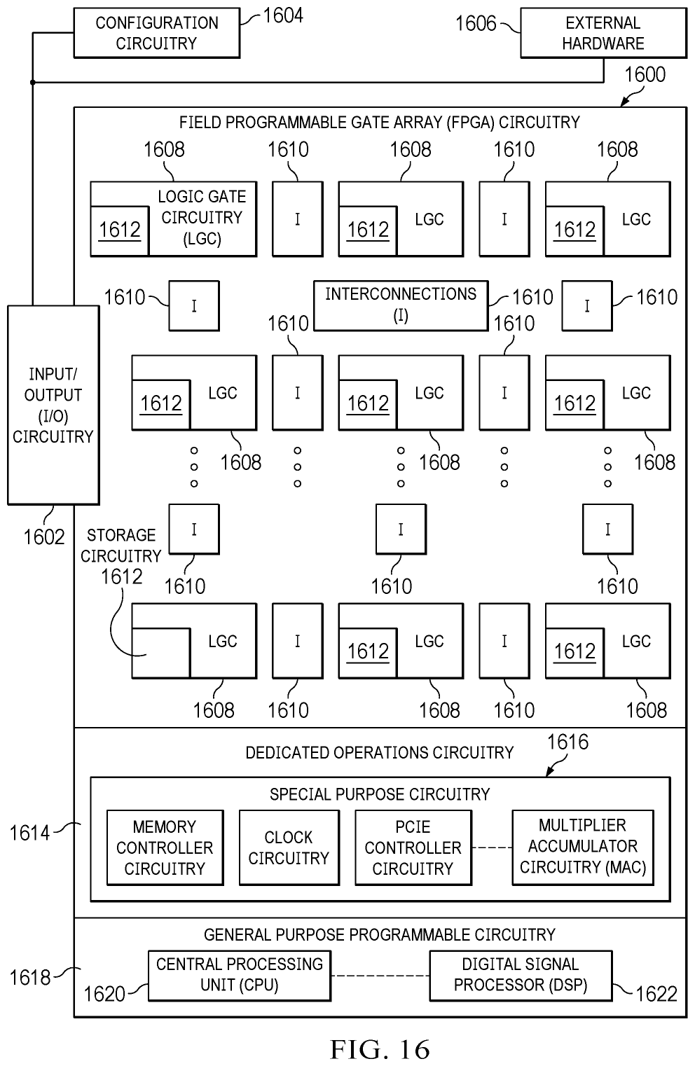

In some examples, the parent device 200 includes means for processing. For example, the means for processing may be implemented by the processing circuitry 202. In some examples, the processing circuitry 202 may be instantiated by processing circuitry such as the example processing circuitry 1312 of FIG. 13. For instance, the processing circuitry 202 may be instantiated by the example microprocessor 1500 of FIG. 15 executing machine-executable instructions such as those implemented by at least blocks 604, 606, 608, 610, 612, 614, 616, and 618 of FIG. 6, at least blocks 702, 704, 706, 708, 710, 712, 714, 716, 718, 720, 722, 724, and 726 of FIG. 7, at least blocks 1002, 1004, 1006, 1008, and 1010 of FIG. 10, and/or at least blocks 1104, 1106, 1108, 1110, and 1114 of FIG. 11. In some examples, the processing circuitry 202 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the processing circuitry 202 may be instantiated by any other combination of hardware, software, and/or firmware. For example, the processing circuitry 202 may be implemented by at least one or more hardware circuits (e.g., processor circuitry, discrete and/or integrated analog and/or digital circuitry, an FPGA, an ASIC, an XPU, a comparator, an operational amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the means for processing includes means for controlling communication. For example, the means for controlling communication may be implemented by the communication control circuitry 204. In some examples, the communication control circuitry 204 may be instantiated by processing circuitry such as the example processing circuitry 1312 of FIG. 13. For instance, the communication control circuitry 204 may be instantiated by the example microprocessor 1500 of FIG. 15 executing machine-executable instructions such as those implemented by at least blocks 604, 610, 612, 616, and 618 of FIG. 6, at least blocks 702, 704, 708, 710, 714, 718, 722, and 726 of FIG. 7, at least blocks 1002, 1004, 1006, 1008, and 1010 of FIG. 10, and/or at least blocks 1104, 1106, 1108, 1110, and 1114 of FIG. 11. In some examples, the communication control circuitry 204 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the communication control circuitry 204 may be instantiated by any other combination of hardware, software, and/or firmware. For example, the communication control circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the means for processing includes means for controlling timing. For example, the means for controlling timing may be implemented by the channel timing circuitry 206. In some examples, the channel timing circuitry 206 may be instantiated by processing circuitry such as the example processing circuitry 1312 of FIG. 13. For instance, the channel timing circuitry 206 may be instantiated by the example microprocessor 1500 of FIG. 15 executing machine-executable instructions such as those implemented by at least blocks 608 and 614 of FIG. 6 and/or at least blocks 706, 712, 716, 720, and 724 of FIG. 7. In some examples, the channel timing circuitry 206 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the channel timing circuitry 206 may be instantiated by any other combination of hardware, software, and/or firmware. For example, the channel timing circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the antenna 210 is coupled to the transmitter circuitry 214 and the receiver circuitry 216. In the example of FIG. 2, the antenna 210 may be implemented by a monopole antenna, a dipole antenna, an array antenna, a large loop antenna, a travelling wave antenna, an aperture antenna, among others. In the example of FIG. 2, the antenna 210 emits signals into and detects signals from an environment in which the parent device 200 is disposed.

In the illustrated example of FIG. 2, the interface circuitry 212 is coupled to the processing circuitry 202 and the antenna 210. In some examples, the interface circuitry 212 is implemented by one or more transmitters and one or more receivers. Additionally or alternatively, the interface circuitry 212 is implemented by one or more transceivers. As described above, in the example of FIG. 2, the interface circuitry 212 includes the transmitter circuitry 214 and the receiver circuitry 216. In the example of FIG. 2, the transmitter circuitry 214 is coupled to the processing circuitry 202 and the antenna 210. The example transmitter circuitry 214 of FIG. 2 is implemented by physical layer circuitry. For example, the transmitter circuitry 214 includes physical coding sublayer circuitry and physical medium dependent layer circuitry. In the example of FIG. 2, the receiver circuitry 216 is coupled to the processing circuitry 202 and the antenna 210. The example receiver circuitry 216 of FIG. 2 is implemented by physical layer circuitry. For example, the receiver circuitry 216 includes physical coding sublayer circuitry and physical medium dependent layer circuitry.

In the illustrated example of FIG. 2, the memory 218 is coupled to the processing circuitry 202. The example memory 218 of FIG. 2 is configured to store data. For example, the memory 218 can store one or more files indicative of synchronization information, information communicated in a discovery request from a candidate child device, information communicated from one or more parent devices, one or more connectivity metrics for child devices synchronized with the parent device 200, and/or any other values. Additionally, the memory 218 stores one or more files indicative of the instructions 220. For example, the instructions 220 may be implemented by the machine-readable instructions of FIGS. 6, 7, 10, and/or 11. In the example of FIG. 2, the memory 218 may be implemented by a volatile memory (e.g., a Synchronous Dynamic Random-Access Memory (SD RAM), DRAM, RAMBUS Dynamic Random-Access Memory (RDRAM), etc.) and/or a non-volatile memory (e.g., flash memory). The example memory 218 may additionally or alternatively be implemented by one or more double data rate (DDR) memories, such as DDR, DDR2, DDR3, DDR4, mobile DDR (mDDR), etc.

In additional or alternative examples, the example memory 218 may be implemented by one or more mass storage devices such as hard disk drive(s), compact disk drive(s), digital versatile disk drive(s), solid-state disk drive(s), etc. While in the illustrated example the memory 218 is illustrated as a single database, the memory 218 may be implemented by any number and/or type(s) of databases. Furthermore, the data stored in the memory 218 may be in any data format such as, for example, binary data, comma delimited data, tab delimited data, structured query language (SQL) structures, etc.

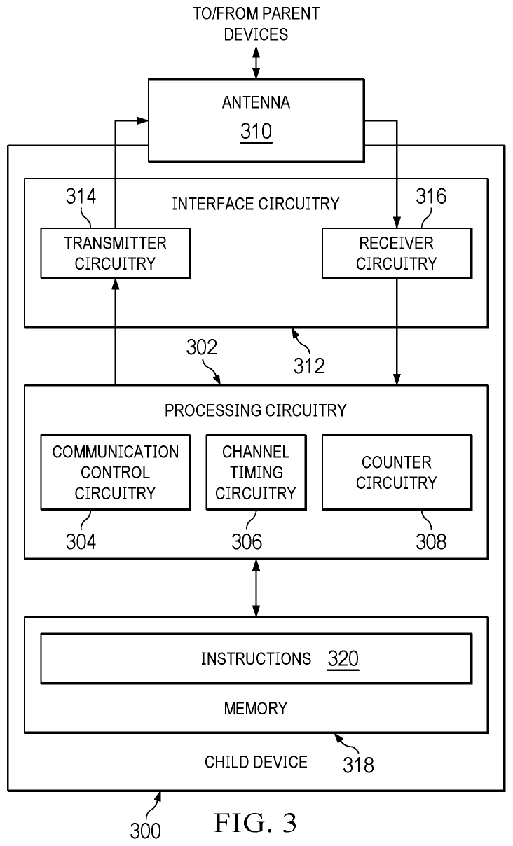

FIG. 3 is a block diagram of an example implementation of a child device 300 in the network 100 of FIG. 1. For example, one or more of the first endpoint device 108A, the second endpoint device 108B, the third endpoint device 108c, the fourth endpoint device 108n, the fifth endpoint device 110A, the sixth endpoint device 110B, the seventh endpoint device 110_{C}, and the eighth endpoint device 110n may be implemented by the child device 300. In the example of FIG. 3, the child device 300 includes example processing circuitry 302. The example processing circuitry 302 of FIG. 3 includes example communication control circuitry 304, example channel timing circuitry 306, and example counter circuitry 308. The example child device 300 of FIG. 3 also includes an antenna 310 and example interface circuitry 312. The example interface circuitry 312 includes example transmitter circuitry 314 and example receiver circuitry 316. Additionally, in the example of FIG. 3, the child device 300 includes example memory 318. The example memory 318 includes example instructions 320.

In the example of FIG. 3, the child device 300 may be instantiated (e.g., creating an instance of, bring into being for any length of time, materialize, implement, etc.) by processing circuitry such as a CPU executing first instructions. Additionally or alternatively, the child device 300 of FIG. 3 may be instantiated (e.g., creating an instance of, bring into being for any length of time, materialize, implement, etc.) by (i) an ASIC and/or (ii) a FPGA structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

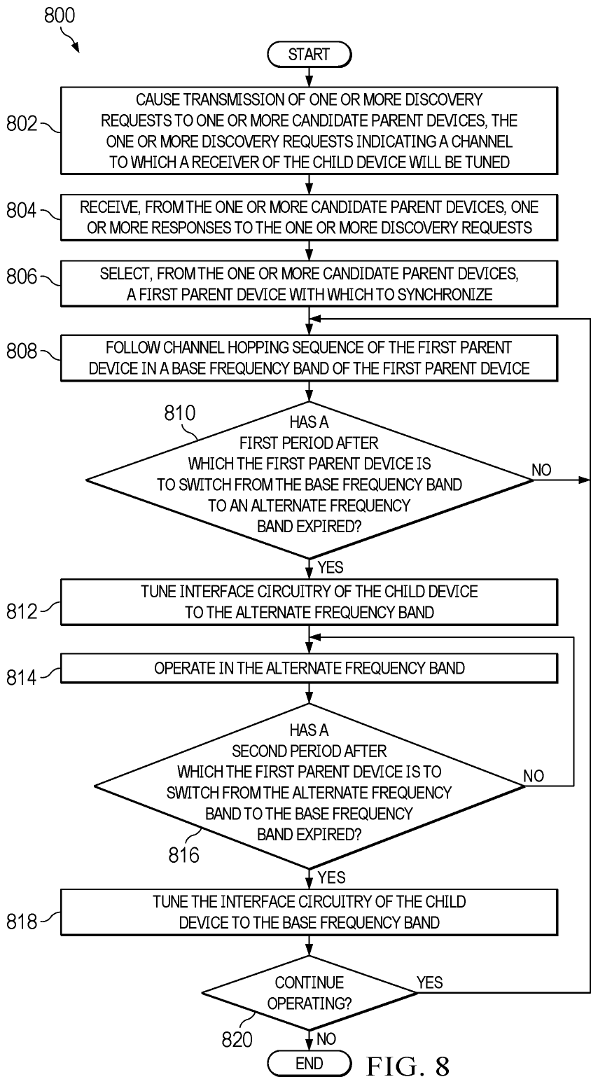

In the illustrated example of FIG. 3, the processing circuitry 302 is coupled to the interface circuitry 312 and the memory 318. For example, the processing circuitry 302 is coupled to the transmitter circuitry 314, the receiver circuitry 316, and the memory 318. In the example of FIG. 3, the processing circuitry 302 may be implemented by one or more CPUs, one or more ASICs, and/or one or more FPGAs. In some examples, the processing circuitry 302 is instantiated by processing circuitry executing parent instructions and/or configured to perform operations such as those represented by the flowchart(s) of FIGS. 8, 9, 12, and/or 20.

In the illustrated example of FIG. 3, the communication control circuitry 304 may be implemented by one or more CPUs, one or more ASICs, and/or one or more FPGAs. In the example of FIG. 3, the communication control circuitry 304 searches a network for one or more candidate parent devices. For example, the communication control circuitry 304 causes transmission of one or more discovery requests. In the example of FIG. 3, the communication control circuitry 304 repeatedly causes transmission of the one or more discovery requests on all channels supported by the child device 300. As such, at least one of the channels will overlap with a channel to which a candidate parent device is tuned. Example discovery requests include information identifying a channel to which the communication control circuitry 304 will tune the interface circuitry 312 for a predetermined period of time. As such, after receiving a discovery request, when a candidate parent device is tuned to the channel identified in the discovery request, the candidate parent device transmits a response to the discovery request including synchronization information.

In the illustrated example of FIG. 3, after the child device 300 (e.g., the receiver circuitry 316) receives one or more responses to one or more discovery requests, the communication control circuitry 304 selects one of one or more candidate parent devices with which the child device 300 is to synchronize. For example, the communication control circuitry 304 selects a candidate parent device that has a strongest connectivity to the child device 300 amongst the one or more candidate parent devices. In the example of FIG. 3, the communication control circuitry 304 computes a received signal strength indicator (RSSI) value for each candidate parent device from which the child device 300 received a response and selects the candidate parent device with the highest RSSI value. Connectivity strength may also be measured in terms of bit error rate (BER), link quality indicator (LQI), among other connectivity metrics. In the example of FIG. 3, the communication control circuitry 304 causes storage of the synchronization information of the selected parent device in the memory 318.

In the illustrated example of FIG. 3, based on the synchronization information, the processing circuitry 302 synchronizes channel hopping with the selected parent device. For example, the communication control circuitry 304 and the channel timing circuitry 306 perform channel hopping according to the synchronization information. For example, according to the synchronization information, the communication control circuitry 304 tunes the interface circuitry 312 to a channel and operates in the channel for a dwell time. Additionally, for example, based on the pseudo-random sequence identified in the synchronization information, the communication control circuitry 304 computes the channel to which the interface circuitry 312 is to be tuned. In the example of FIG. 3, the communication control circuitry 304 communicates (e.g., performs one or more data exchanges) with the parent device in the channel for a dwell time.

In the illustrated example of FIG. 3, the child device 300 may utilize CSL. For example, when the parent device is not communicating with the child device 300, the communication control circuitry 304 places the child device 300 into a sleep mode of operation. For example, to place the child device 300 in the sleep mode of operation, the communication control circuitry 304 turns off the interface circuitry 312. At a specified time, the communication control circuitry 304 places the child device 300 into a wake mode of operation. For example, to place the child device 300 in the wake mode of operation, the communication control circuitry 304 turns on the interface circuitry 312. Additionally, at the specified time, the communication control circuitry 304 tunes the interface circuitry 312 to a channel in which the parent device is expected to be operating and operates in the channel. In the example of FIG. 3, based on a dwell time expiring, the communication control circuitry 304 determines whether a data exchange in the channel has expired. For example, when the child device 300 is utilizing CSL and the child device 300 and the parent device are exchanging data when the dwell time expires, the communication control circuitry 304 maintains the current tuning of the interface circuitry 312 until the data exchange is complete (e.g., until the communication control circuitry 304 receives an acknowledgement packet from the parent device and/or causes transmission of an acknowledgement packet to the parent device).

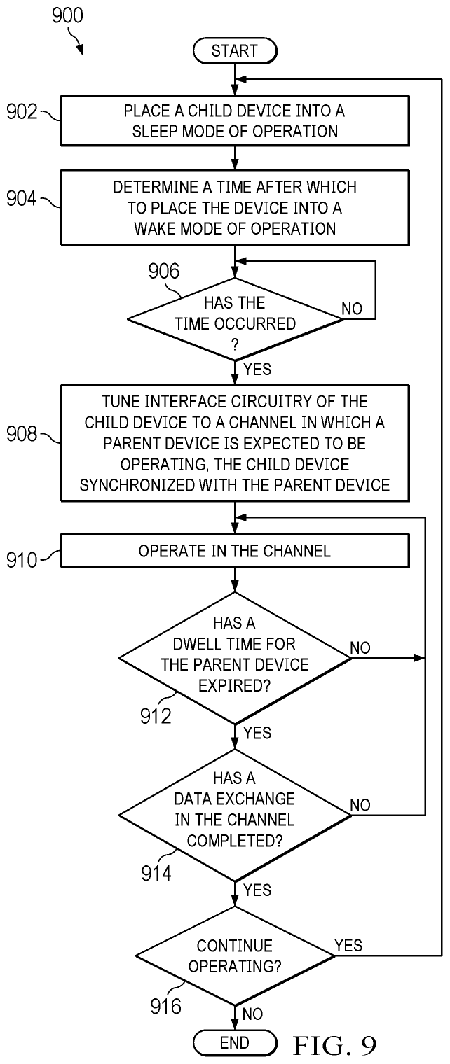

In the illustrated example of FIG. 3, the parent device with which the child device 300 is synchronized may inform the child device 300 of another parent device with which the child device 300 has a stronger connection. For example, if the child device 300 is synchronized with a first parent device, the first parent device may notify the child device 300 of a second parent device with stronger connectivity to the child device 300 than the first parent device. Based on receiving such a notification from the first parent device, the communication control circuitry 304 causes transmission of a discovery request to the second parent device and synchronizes with the second parent device after receiving a response from the second parent device. In some examples, the communication control circuitry 304 is instantiated by processing circuitry executing communication control instructions and/or configured to perform operations such as those represented by the flowchart(s) of FIGS. 8, 9, and/or 12.

In the illustrated example of FIG. 3, the channel timing circuitry 306 may be implemented by one or more CPUs, one or more ASICs, and/or one or more FPGAs. In the example of FIG. 3, the channel timing circuitry 306 controls the counter circuitry 308. For example, the channel timing circuitry 306 sets one or more counters of the counter circuitry 308 to track a dwell time of the parent device with which the child device 300 is synchronized. For example, the channel timing circuitry 306 sets one or more counters of the counter circuitry 308 to count down from the dwell time identified in the synchronization information. Additionally or alternatively, the channel timing circuitry 306 sets one or more counters of the counter circuitry 308 to count up to the dwell time identified in the synchronization information. In the example of FIG. 3, the channel timing circuitry 306 determines whether the one or more dwell times have expired. For example, the channel timing circuitry 306 determines whether the one or more counters have counted down from the predefined value. Additionally or alternatively, the channel timing circuitry 306 determines whether the one or more counters have counted up to the predefined value.

In the illustrated example of FIG. 3, the channel timing circuitry 306 sets one or more counters of the counter circuitry 308 to track the number of slots utilized for each dwell time of the parent device with which the child device 300 is synchronized. For example, the channel timing circuitry 306 sets one or more counters of the counter circuitry 308 to count down from the DWELL_TIME_SWITCH parameter identified in the synchronization information. Additionally or alternatively, the channel timing circuitry 306 sets one or more counters of the counter circuitry 308 to count up to the DWELL_TIME_SWITCH parameter identified in the synchronization information. In the example of FIG. 3, the channel timing circuitry 306 determines whether the DWELL_TIME_SWITCH period has expired. For example, the channel timing circuitry 306 determines whether the one or more counters have counted down from the predefined value. Additionally or alternatively, the channel timing circuitry 306 determines whether the one or more counters have counted up to the predefined value.

In the illustrated example of FIG. 3, based on the channel timing circuitry 306 determining that the DWELL_TIME_SWITCH period has expired, the channel timing circuitry 306 utilizes a second dwell time. For example, the channel timing circuitry 306 sets one or more counters of the counter circuitry 308 to track the second dwell time. As described above, other parent devices (e.g., parent devices with which the child device 300 is not synchronized) utilize different dwell times from the parent. As such, if another parent device has stronger connectivity with the child device 300, the child device 300 can detect the other parent device and connect to the parent device. In some examples, the channel timing circuitry 306 is instantiated by processing circuitry executing channel timing instructions and/or configured to perform operations such as those represented by the flowchart(s) of FIGS. 8 and/or 9.

In the illustrated example of FIG. 3, the counter circuitry 308 may be implemented by one or more CPUs, one or more ASICs, and/or one or more FPGAs. In the example of FIG. 3, the counter circuitry 308 includes one or more counters to track one or more dwell times, a period (in terms of slots) after which a parent device is to switch from a base frequency band (e.g., the sub-1 GHz frequency band) to an alternate frequency band (e.g., the 2.4 GHz frequency band), a period (in terms of slots) after which the parent device is to switch from the alternate frequency band to the base frequency band, and/or a period (in terms of slots) after which the channel timing circuitry 306 is to alternate dwell times. In some examples, the counter circuitry 308 is instantiated by processing circuitry executing counter instructions and/or configured to perform operations.

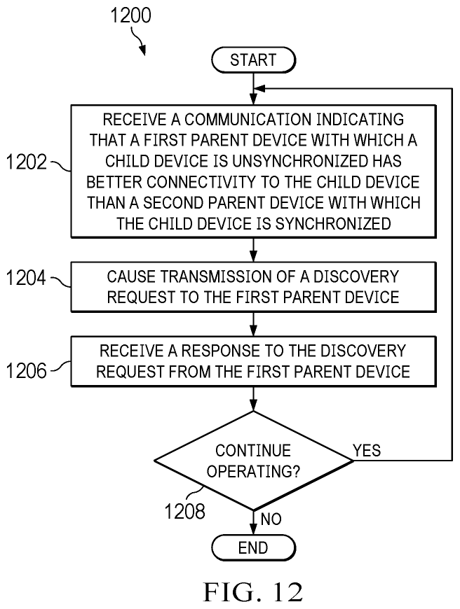

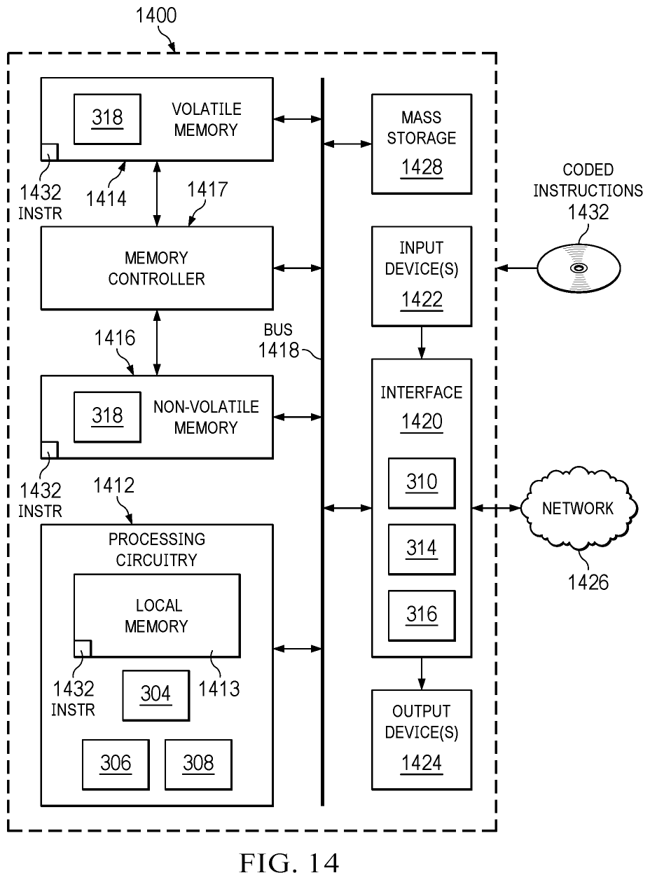

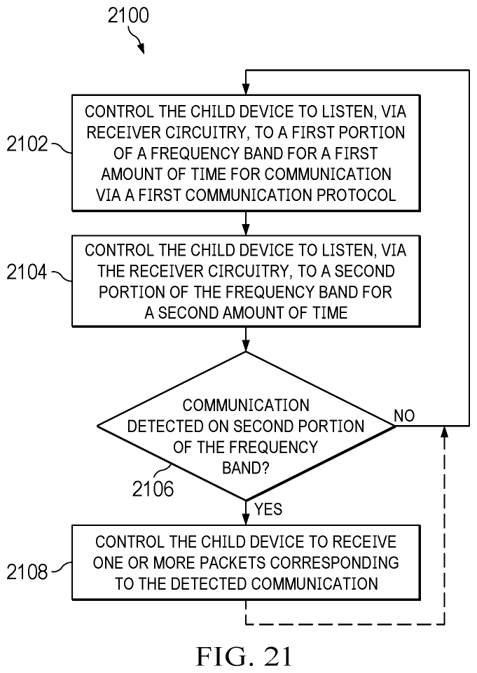

In some examples, the child device 300 includes means for processing. For example, the means for processing may be implemented by the processing circuitry 302. In some examples, the processing circuitry 302 may be instantiated by processing circuitry such as the example processing circuitry 1412 of FIG. 14. For instance, the processing circuitry 302 may be instantiated by the example microprocessor 1500 of FIG. 15 executing machine-executable instructions such as those implemented by at least blocks 802, 806, 808, 810, 812, 814, 816, 818, and 820 of FIG. 8, at least blocks 902, 904, 906, 908, 910, 912, 914, and 916 of FIG. 9, at least blocks 1204 and 1208 of FIG. 12, and/or operations 2102, 2104, 2105, 2106, and 2108 of FIG. 21. In some examples, the processing circuitry 302 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the processing circuitry 302 may be instantiated by any other combination of hardware, software, and/or firmware. For example, the processing circuitry 302 may be implemented by at least one or more hardware circuits (e.g., processor circuitry, discrete and/or integrated analog and/or digital circuitry, an FPGA, an ASIC, an XPU, a comparator, an operational amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the means for processing includes means for controlling communication. For example, the means for controlling communication may be implemented by the communication control circuitry 304. In some examples, the communication control circuitry 304 may be instantiated by processing circuitry such as the example processing circuitry 1412 of FIG. 14. For instance, the communication control circuitry 304 may be instantiated by the example microprocessor 1500 of FIG. 15 executing machine-executable instructions such as those implemented by at least blocks 802, 806, 812, 814, 818, and 820 of FIG. 8, at least blocks 902, 908, 910, 914, and 916 of FIG. 9, at least blocks 1204 and 1208 of FIG. 12, and/or operations 2102, 2104, 2105, 2106, and 2108 of FIG. 21. In some examples, the communication control circuitry 304 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the communication control circuitry 304 may be instantiated by any other combination of hardware, software, and/or firmware. For example, the communication control circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the means for processing includes means for controlling timing. For example, the means for controlling timing may be implemented by the channel timing circuitry 306. In some examples, the channel timing circuitry 306 may be instantiated by processing circuitry such as the example processing circuitry 1412 of FIG. 14. For instance, the channel timing circuitry 306 may be instantiated by the example microprocessor 1500 of FIG. 15 executing machine-executable instructions such as those implemented by at least blocks 810 and 816 of FIG. 8 and/or at least blocks 904, 906, and 912 of FIG. 9. In some examples, the channel timing circuitry 306 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the channel timing circuitry 306 may be instantiated by any other combination of hardware, software, and/or firmware. For example, the channel timing circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 3, the antenna 310 is coupled to the transmitter circuitry 314 and the receiver circuitry 316. In the example of FIG. 3, the antenna 310 may be implemented by a monopole antenna, a dipole antenna, an array antenna, a large loop antenna, a travelling wave antenna, an aperture antenna, among others. In the example of FIG. 3, the antenna 310 emits signals into and detects signals from an environment in which the child device 300 is disposed.

In the illustrated example of FIG. 3, the interface circuitry 312 is coupled to the processing circuitry 302 and the antenna 310. In some examples, the interface circuitry 312 is implemented by one or more transmitters and one or more receivers. Additionally or alternatively, the interface circuitry 312 is implemented by one or more transceivers. As described above, in the example of FIG. 3, the interface circuitry 312 includes the transmitter circuitry 314 and the receiver circuitry 316. In the example of FIG. 3, the transmitter circuitry 314 is coupled to the processing circuitry 302 and the antenna 310. The example transmitter circuitry 314 of FIG. 3 is implemented by physical layer circuitry. For example, the transmitter circuitry 314 includes physical coding sublayer circuitry and physical medium dependent layer circuitry. In the example of FIG. 3, the receiver circuitry 316 is coupled to the processing circuitry 302 and the antenna 310. The example receiver circuitry 316 of FIG. 3 is implemented by physical layer circuitry. For example, the receiver circuitry 316 includes physical coding sublayer circuitry and physical medium dependent layer circuitry. In some examples, the interface circuitry 312, transmitter circuitry 314, and/or receiver circuitry 316 are implemented as a component or components of a RF radio including, or coupled to, the antenna 310.

In the illustrated example of FIG. 3, the memory 318 is coupled to the processing circuitry 302. The example memory 318 of FIG. 3 is configured to store data. For example, the memory 318 can store one or more files indicative of synchronization information for the parent device to which the child device is synchronized, information to be communicated in a discovery request from the child device 300, one or more connectivity metrics for one or more candidate parent devices, and/or any other values. Additionally, the memory 318 stores one or more files indicative of the instructions 320. For example, the instructions 320 may be implemented by the machine-readable instructions of FIGS. 8, 9, and/or 12. In the example of FIG. 3, the memory 318 may be implemented by a volatile memory (e.g., a SDRAM, DRAM, RDRAM, etc.) and/or a non-volatile memory (e.g., flash memory). The example memory 318 may additionally or alternatively be implemented by one or more DDR memories, such as DDR, DDR2, DDR3, DDR4, mDDR, etc.

In additional or alternative examples, the example memory 318 may be implemented by one or more mass storage devices such as hard disk drive(s), compact disk drive(s), digital versatile disk drive(s), solid-state disk drive(s), etc. While in the illustrated example the memory 318 is illustrated as a single database, the memory 318 may be implemented by any number and/or type(s) of databases. Furthermore, the data stored in the memory 318 may be in any data format such as, for example, binary data, comma delimited data, tab delimited data, SQL structures, etc.

In the illustrated example of FIG. 3, the communication control circuitry 304 may also, or alternatively, time multiplex operation of the interface circuitry 312, such that the receiver circuitry 316 performs packet detection among multiple communication protocols, including at least a first and a second communication protocol. For example, the communication control circuitry 304 may control the interface circuitry 312 to tune the receiver circuitry 316 to a first channel (e.g., in a first frequency band, such as 2.4 GHz) associated with the first communication protocol (e.g., Zigbee®) for a first amount of time. In some examples, the first amount of time is determined based on a packet size of packets defined according to the first communication protocol, a (e.g., standard-specified) backoff time of the first communication protocol, and a random value within a defined range (such as about 0-2 ms). In some examples, the first amount of time is in a range of about 7 ms to 9 ms. In some examples, to perform the tuning, the communication control circuitry 304 controls the interface circuitry to modify a center frequency of a filter, such as a bandpass filter, of the receiver circuitry 316 to a frequency associated with a channel of interest. In some examples, the communication control circuitry 304 determines the center frequency according to a lookup table or other data store that includes associations between channels and their related center frequencies. To listen for communication on the first channel, the communication control circuitry 304 may also modify (e.g., programs or loads) physical layer (PHY) configuration data of the receiver circuitry 316, such as a modem of the receiver circuitry 316. For example, the communication control circuitry 304 may load PHY configuration data corresponding to the first communication protocol to the receiver circuitry 316.

At a second time, occurring at expiration of the first amount of time, the communication control circuitry 304 may control the interface circuitry 312 to tune the receiver circuitry 316 to a second channel (e.g., in the first frequency band, such as 2.4 GHz) associated with the second communication protocol (e.g., BLE) for a second amount of time. The communication control circuitry 304 may also modify (e.g., programs or loads) PHY configuration data of the receiver circuitry 316, such as a modem of the receiver circuitry 316. For example, the communication control circuitry 304 may load PHY configuration data corresponding to the second communication protocol to the receiver circuitry 316. In some examples, the second amount of time is determined to cause a probability of detecting a preamble of a packet associated with the second communication protocol, or other information signifying the commencement of receipt of a packet according to the second communication protocol, e.g., as determined according to a binomial distribution as described below, to be greater than or equal to approximately, e.g., ten percent during an advertisement interval of the second communication protocol. In some examples, the second amount of time is (e.g., initially, such as in the absence of preamble detection) about 1200 μs. Responsive to detecting or receiving the preamble of the packet, or other information signifying the commencement of receipt of a packet according to the second communication protocol, the communication control circuitry 304 may extend the second amount of time. For example, the second amount of time may be extended to at least a duration specified for receiving or receiving and processing a packet, such as an advertisement packet, a data packet, or the like, associated with the second communication protocol. In some examples, the second amount of time may be extended to approximately one to approximately three seconds, during which one or more packets associate with the second communication protocol may be received. In some examples, responsive to receipt of the preamble, or a first packet, such as an advertisement packet, in the second channel, the communication control circuitry 304 retunes the receiver circuitry 316 to a third channel (associated with the second communication protocol) to receive an additional packet or packets, such as data packets. Responsive to not receiving or detecting a preamble during the second amount of time, the communication control circuitry 304 permits the second amount of time to expire. In some examples, responsive to expiration of the second amount of time, the communication control circuitry 304 retunes the receiver circuitry 316 to a channel associated with the first communication protocol, such as the first channel, and loads PHY configuration data corresponding to the first communication protocol to the receiver circuitry 316, e.g., to communicate via the first channel.

In some examples, when a preamble is not detected in the second channel, the communication control circuitry 304 controls the receiver circuitry 316 to listen to the first channel for approximately 70-90% of a unit period of time and to the second channel for approximately 10-30% of the unit period of time. A particular ratio from among the recited ranges may be determined based on the random value included in determining the first amount of time, as described above.

Following the second amount of time, the communication control circuitry 304 retunes the receiver circuitry 316 back to a channel associated with the first communication protocol, such as the first channel, and reprograms the receiver circuitry 316 with PHY configuration data corresponding to the first communication protocol. In some embodiments, such as in embodiments in which the first protocol uses channel hopping, following the second amount of time, the communication control circuitry 304 may retune the receiver circuitry 316 to another channel (different from the first channel) associated with the first communication protocol, and reprograms the receiver circuitry 316 with PHY configuration data corresponding to the first communication protocol.

Retuning of the receiver circuitry 316 from the first channel to the second channel (including reprogramming of PHY configuration data of the receiver circuitry 316 from the first communication protocol to the second communication protocol), and vice versa, may consume a third amount of time. In some examples, the third amount of time is about 400 μs.

In this way, the communication control circuitry 304 controls the interface circuitry 312 to listen or monitor for communication via the first communication protocol (e.g., even in the absence of communication detection associated with the first communication protocol) for a greater amount of time than the second communication protocol, while also listening or monitoring for an indication of a beginning of communication via the second communication protocol. This time-multiplexed operation may advantageously enhance packet detection by the child device 300 by reducing an amount of time for which the child device 300 is not listening to the first channel, while also reducing a probability of missing communication via the second communication protocol as a result of listening to the second channel for a reduced amount of time.

For example, when the child device 300 does not detect a preamble during the second amount of time, in some implementations, the interface circuitry 312 is not listening to the first channel for 3 ms over a 10 ms period. When the child device 300 is implemented in a system that communicates asynchronously with 2 or more consecutive retries for communication, this timing enhances performance of the child device 300. For example, the child device 300 may not miss or experience a loss related to communication via the first communication protocol on the first channel despite spending a nonzero amount of time listening to the second channel, thereby advantageously preventing system level loss in performance of the child device 300.

In some examples, the child device 300 has a probability of detecting a preamble associated with the second communication protocol in the second channel that is related to the second amount of time. For example, for a transmission interval of 100 ms and a preamble duration of approximately 10 μs, approximately one of every 10⁴ time slots will include a preamble. As described above, in some examples, the second amount of time is 1200 μs. In such an example, this provides a probability of detecting a preamble in a 100 ms period of time of approximately 1200/10⁴, or 0.12 (12%), and an 88% chance of not detecting the preamble. By binomial distribution, this corresponds to an approximately 72% probability of detecting a preamble within a one second time period, and an approximately 99% probability of detecting a preamble within a five second time period. Such implementation may be advantageous, e.g., in a system designed for continuous communication in the first protocol (e.g., to communicate sensor data), while also allowing a new node to establish connection with the child device 300 using the second communication. For example, in some embodiments, the child device 300 may communicate sensor data for most of the time using the first communication protocol. When a new device tries to connect to the child device 300 using the second communication protocol, the time duration for establishing a connection may be around 5 seconds or less, which may be connection time that is fast enough such that it feels responsive to a user.

Some examples may use a different transmission interval for the first communication protocol. For example, for a one second transmission interval, the probability of detecting a preamble within a 10 second time period may be approximately 11%, within a 30 second time period may be about 30%, within a 120 second time period may be about 77%, within a 300 second time period may be about 97%, and within a 420 second time period may be about 99%.

In another example, the communication control circuitry 304 may also, or alternatively, perform energy detection to identify communication via the second (or other) channel. For example, some communication protocols (the second communication protocol in this example), may transmit packets, such as advertisement frames or packets, across multiple channels sequentially, or back to back. The channels themselves may be sequential or non-sequential. In one example, the second communication protocol (e.g., BLE) may specify that advertisement packets be transmitted sequentially on channels 37, 38, and 39, having respective center frequencies of 2402 MHz, 2426 MHz, and 2480 MHz. The communication control circuitry 304 may control the receiver circuitry 312 to perform energy detection in at least some of the channels associated with the second communication protocol, without changing a programming of the receiver circuitry 312 from the first communication protocol associated with the first channel to another communication protocol associated with a channel in which energy detection is being performed.

For example, to tune the receiver circuitry 316 to receive packets associated with the second communication protocol in the second channel for the second amount of time, as described above, in addition to tuning the frequency of the receiver circuitry 316 to that of the second channel, the communication control circuitry 304 modifies PHY configuration data of the receiver circuitry 316, such as a modem of the receiver circuitry 316, to process the types of signals (e.g., the type of modulation) associated with the second communication protocol. This may be a time consuming process, consuming about 400 μs of time, as described above. To reduce an amount of time for which the receiver circuitry 312 is not listening for communication on the first channel, in some examples, the communication control circuitry 304 controls the receiver circuitry 312 to perform energy detection in a first of the channels (e.g., advertisement channel 37 associated with BLE) for a fourth amount of time. The energy detection may be performed without modifying the PHY configuration data of the receiver circuitry 316. For example, the receiver circuitry 316 may remain programmed or loaded with PHY configuration data corresponding to the first communication protocol while monitoring the other channel (e.g., channel 37 associated with BLE) for the presence of energy. This may reduce an amount of time spent by the receiver circuitry 316 in transitioning between monitoring of channels, such as compared to the example described above, thereby advantageously increasing an amount of time for which the receiver circuitry 316 is monitoring, or listening, for communications according to the first communication protocol. Responsive to not detecting energy in the channel during the fourth amount of time, the communication control circuitry 304 controls the receiver circuitry 312 to listen for communications according to the first communication protocol (e.g., in the first channel) for the first amount of time. This may be performed by returning the receiver circuitry 312 from the channel to the first channel.

Responsive to detecting energy in the channel (e.g., channel 37 associated with BLE) during the fourth amount of time, the communication control circuitry 304 controls the receiver circuitry 312 to modify (e.g., program or load) PHY configuration data corresponding to the second communication protocol to the receiver circuitry 316, such as a modem of the receiver circuitry 316. The communication control circuitry 304 also controls the receiver circuitry 312 to listen to a subsequent (e.g., advertisement) channel associated with the second communication protocol (e.g., channel 38 or 39 associated with BLE), such as for receiving a retransmission of a packet of which the energy was detected. In some examples, the subsequent channel is a next sequential channel (e.g., channel 38 associated with BLE) following the channel in which the energy was detected. In some examples, the subsequent channel is not sequential to the channel in which the energy was detected. For example, in some embodiments, the energy may be detected in channel 37 associated with BLE and the subsequent channel may be channel 39 associated with BLE.

In some examples, once energy is detected and the receiver circuitry 317 is modified with the PHY configuration data corresponding to the second communication protocol and is listening to the subsequent channel, the communication control circuitry 304 controls the receiver circuitry 312 to remain listening to the subsequent channel until a preamble and advertisement packet according to the second communication protocol have been received. Responsive to receipt of the advertisement packet, the communication control circuitry 304 may control the receiver circuitry 312 to listen to another channel, determined according to the second communication protocol or to contents of the advertisement packet, to receive data, such as in the form of a data packet. In some examples, responsive to failing to detect a preamble associated with the second communication protocol in the subsequent channel, the communication control circuitry 304 retunes the receiver circuitry 316 to a channel associated with the first communication protocol, such as the first channel, and loads PHY configuration data corresponding to the first communication protocol to the receiver circuitry 316, e.g., to communicate via the first communication protocol.

In some examples, such an approach may advantageously further reduce an amount of time for which the receiver circuitry 312 is not listening to the first channel. This may be suitable for application environments in which communication on the second (or other) channel (e.g., communication according to the second communication protocol) is expected to be infrequent, thereby increasing an amount of time available for communicating via the first communication protocol on the first channel. For example, in some embodiments, the time spent by receiver circuitry 312 listening for packets according to the first communication protocol (the first amount of time) may be between 7 ms and 9 ms, and the time spent performing energy detection may be between 400 μs and 500 μs, which may result in receiver circuitry 312 listening for packets in the first communication protocol (e.g., Zigbee®) for more than 90% of the time, while advantageously still being responsive to (e.g., advertisement) packets in the second communication protocol (e.g., BLE).

FIG. 4 is a timing diagram 400 illustrating example channel hopping in the network 100 of FIG. 1 for example parent devices having different dwell times. In the example of FIG. 4, an example child device 402 is synchronized with a first example parent device 404. Additionally, in the example of FIG. 4, the child device 402 is unsynchronized with a second example parent device 406. In the example of FIG. 4, the first parent device 404 and the second parent device 406 utilize different dwell times. As such, the channel hopping sequence of the first parent device 404 overlaps with the channel hopping sequence of the second parent device 406. As a result of the different dwell times, the probability of the child device 402 being tuned to the same channel as the second parent device 406 is increased. For example, a first example slot 408 of the channel hopping sequence of the first parent device 404 overlaps with a second example slot 410 of the channel hopping sequence of the second parent device 406. Additionally, during the first slot 408, the receiver circuitry of the child device 402 is tuned to channel “4” and during the second slot 410, the transmitter circuitry of the second parent device 406 is tuned to channel “4.” As such, during the overlapping period of the first slot 408 of the second slot 410, the child device 402 can detect a communication from the second parent device 406 and determine whether the child device 402 has a stronger connectivity with the second parent device 406 than the first parent device 404.

Additionally, by dynamically modifying dwell times through channel hopping sequences, example parent devices further increase the probability of a child device detecting a communication from a parent device to which the child device is not synchronized. For example, each parent device can include a DWELL_TIME_SWITCH parameter that defines a period (in terms of slots) after which each parent device is to alternate dwell times. For example, the example synchronization information illustrated in Table 1 above indicates that a parent device (e.g., the parent device 200) is to alternate between a dwell time of 50 ms and 250 ms every 50 slots. In the example of Table 1, the parent device (e.g., the parent device 200) is to utilize a dwell time of 50 ms for slots 0 to 49, 100-149, 200-249, etc., and is to utilize a dwell time of 250 ms for slots 50 to 99, 150 to 199, etc. The number of dwell times utilized by a parent device can vary from two different dwell times to any N different dwell times.

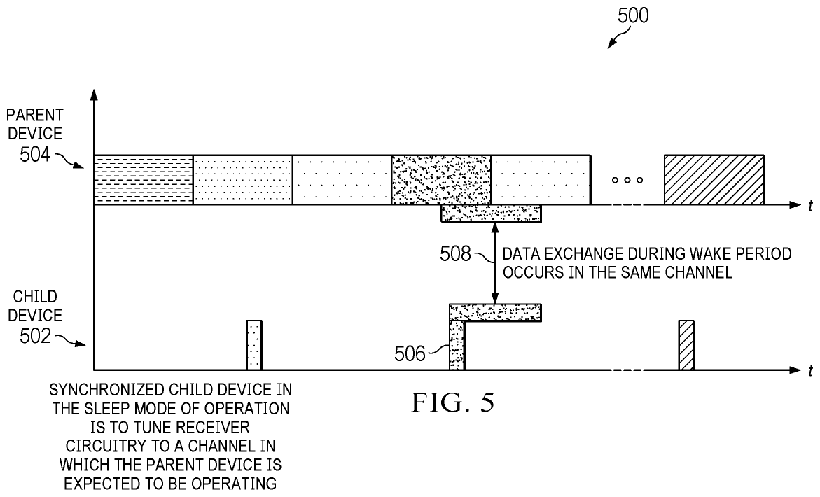

FIG. 5 is a timing diagram 500 illustrating example channel hopping in the network 100 of FIG. 1 for an example child device 502 in a sleep mode of operation and an example parent device 504. In the example of FIG. 5, the child device 502 is synchronized with the parent device 504 and the child device 502 is utilizing CSL. For example, during periods when the child device 502 is not scheduled to exchange data with the parent device 504, the child device 502 switches from a wake mode of operation to a sleep mode of operation (e.g., turns off interface circuitry of the child device 502). Additionally, during periods when the child device 502 is scheduled to exchange data with the parent device 504, the child device 502 switches from the sleep mode of operation to the wake mode of operation (e.g., turns on the interface circuitry of the child device 502).

In the illustrated example of FIG. 5, when the child device 502 switches to the wake mode of operation, the child device 502 tunes to a specific channel in which the parent device 504 is expected to be operating. For example, if the child device 502 is to receive data during an example scheduled wake period 506, the child device 502 tunes receiver circuitry of the child device 502 to the channel in which transmitter circuitry of the parent device 504 is expected to be operating. Additionally, for example, if the child device 502 is to transmit data during the example scheduled wake period 506, the child device 502 tunes transmitter circuitry of the child device 502 to the channel in which receiver circuitry of the parent device 504 is expected to be operating.

In the illustrated example of FIG. 5, if an example data exchange 508 between the child device 502 and the parent device 504 exceeds the duration of the scheduled wake period 506 (e.g., the slot duration), the child device 502 and the parent device 504 will continue to operate in the channel to which the devices (e.g., the child device 502 and the parent device 504) were tuned at the start of the scheduled wake period 506. As such, the example data exchange 508 during the scheduled wake period 506 occurs in the same channel. In other words, the child device 502 and the parent device 504 may be configured to communicate on a single channel for the entirety of the data exchange 508 that is to occur during the scheduled wake period 506. Additionally, in the example of FIG. 5, if the start of the scheduled wake period 506 is within a threshold amount of time of a transition on channels on the parent device 504, the child device 502 and the parent device 504 may be configured to utilize the next channel in the channel hopping sequence for the scheduled wake period 506. In such examples, the child device 502 and the parent device 504 may be configured to communicate on the next channel during the scheduled wake period 506 based on (e.g., in response to) determining that the scheduled transition to the next channel is to occur less than the threshold amount of time from the start of the scheduled wake period 506. As such, examples described herein enable channel hopping with CSL capable devices.

While an example manner of implementing the parent device 200 of FIG. 2 is illustrated in FIG. 2, one or more of the elements, processes, and/or devices illustrated in FIG. 2 may be combined, divided, re-arranged, omitted, eliminated, and/or implemented in any other way. Additionally, while an example manner of implementing the child device 300 of FIG. 3 is illustrated in FIG. 3, one or more of the elements, processes, and/or devices illustrated in FIG. 3 may be combined, divided, re-arranged, omitted, eliminated, and/or implemented in any other way. Further, the example processing circuitry 202, the example communication control circuitry 204, the example channel timing circuitry 206, the example counter circuitry 208, the example antenna 210, the example interface circuitry 212, the example transmitter circuitry 214, the example receiver circuitry 216, the example memory 218, and/or, more generally, the example parent device 200 of FIG. 2 and/or the example processing circuitry 302, the example communication control circuitry 304, the example channel timing circuitry 306, the example counter circuitry 308, the example antenna 310, the example interface circuitry 312, the example transmitter circuitry 314, the example receiver circuitry 316, the example memory 318, and/or, more generally, the example child device 300 of FIG. 3, may be implemented by hardware alone or by hardware in combination with software and/or firmware. Thus, for example, any of the example communication control circuitry 204, the example channel timing circuitry 206, the example counter circuitry 208, and/or, more generally, the example processing circuitry 202 of FIG. 2 and/or the example communication control circuitry 304, the example channel timing circuitry 306, the example counter circuitry 308, and/or, more generally, the example processing circuitry 302 of FIG. 3, could be implemented by processing circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example parent device 200 of FIG. 2 may include one or more elements, processes, and/or devices in addition to, or instead of, those illustrated in FIG. 2, and/or may include more than one of any or all of the illustrated elements, processes, and devices. Additionally, the example child device 300 of FIG. 3 may include one or more elements, processes, and/or devices in addition to, or instead of, those illustrated in FIG. 3, and/or may include more than one of any or all of the illustrated elements, processes, and devices.

Flowchart(s) representative of example machine-readable instructions, which may be executed by processing circuitry (e.g., the instructions to cause processing circuitry) to implement and/or instantiate the parent device 200 of FIG. 2 and/or representative of example operations which may be performed by processing circuitry to implement and/or instantiate the parent device 200 of FIG. 2, are shown in FIGS. 6, 7, 10, and/or 11. Additionally, flowchart(s) representative of example machine-readable instructions, which may be executed by processing circuitry (e.g., the instructions to cause processing circuitry) to implement and/or instantiate the child device 300 of FIG. 3 and/or representative of example operations which may be performed by processing circuitry to implement and/or instantiate the child device 300 of FIG. 3, are shown in FIGS. 8, 9, and/or 12. The machine-readable instructions may be one or more executable programs or portion(s) of one or more executable programs for execution by processing circuitry such as the processing circuitry 1312 shown in the example processing circuitry platform 1300 described below in connection with FIG. 13, the processing circuitry 1412 shown in the example processing circuitry platform 1400 described below in connection with FIG. 14, and/or may be one or more function(s) or portion(s) of functions to be performed by the example processing circuitry (e.g., an FPGA) described below in connection with FIGS. 15 and/or 16. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by processing circuitry located in one or more hardware devices, but the entirety of the program(s) and/or parts thereof could alternatively be executed and/or instantiated by one or more hardware devices other than the processing circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program(s) is/are described with reference to the flowchart(s) illustrated in FIGS. 6, 7, 10, and/or 11, many other methods of implementing the example parent device 200 of FIG. 2 may alternatively be used. Additionally, although the example program(s) is/are described with reference to the flowchart(s) illustrated in FIGS. 8, 9, and/or 12, many other methods of implementing the example child device 300 of FIG. 3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processing circuitry may be distributed in different network locations and/or local to one or more hardware devices (e.g., a single-core processor (e.g., a single core CPU), a multi-core processor (e.g., a multi-core CPU, an XPU, etc.)). For example, the processing circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof An example XPU may be implemented by a heterogeneous computing system including multiple types of processing circuitry (e.g., one or more FPGAs, one or more CPUs, one or more GPUs, one or more network processing units (NPUs), one or more DSPs, etc., and/or any combination(s) thereof), and orchestration technology (e.g., application programming interface(s) (API(s)) that may assign computing task(s) to whichever one(s) of the multiple types of processing circuitry is/are suited and available to perform the computing task(s).

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by processing circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperTextMarkup Language (HTML), Structured Query Language (SQL), Swift, etc.

As mentioned above, the example operations of FIGS. 6, 7, 8, 9, 10, 11, and/or 12 may be implemented using executable instructions (e.g., computer-readable and/or machine-readable instructions) stored on one or more non-transitory computer-readable and/or machine-readable media. As used herein, the terms non-transitory computer-readable medium, nontransitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine-readable instructions and/or example operations 600 that may be executed, instantiated, and/or performed using an example processing circuitry implementation of the parent device 200 of FIG. 2 to perform channel hopping across multiple frequency bands. The example machine-readable instructions and/or the example operations 600 as described can be performed by a parent device (e.g., the parent device 200). The example machine-readable instructions and/or the example operations 600 of FIG. 6 begin at block 602, at which the interface circuitry 212 receives a discovery request from a candidate child device. For example, at block 602, the receiver circuitry 216 receives a discovery request from a candidate child device. As described above, a discovery request identifies a specific channel to which interface circuitry of the candidate child device will be tuned for a predetermined period of time.

In the illustrated example of FIG. 6, at block 604, the processing circuitry 202 causes transmission of a response to the discovery request, the response including synchronization information. For example, at block 604, the communication control circuitry 204 causes, via the interface circuitry 212, transmission of a response to the discovery request, the response including synchronization information. In the example of FIG. 6, the communication control circuitry 204 causes transmission of the response to the discovery request in the channel identified by the discovery request. Example synchronization information includes data identifying a base frequency band of the parent device 200, an alternate frequency band of the parent device 200, a first period (in terms of slots) after which to switch from the base frequency band to the alternate frequency band, and a second period (in terms of slots) after which to switch from the alternate frequency band to the base frequency band.

In the illustrated example of FIG. 6, at block 606, the processing circuitry 202 performs channel hopping in the base frequency band. For example, FIG. 7 is a flowchart representative of example machine-readable instructions and/or example operations 700 that may be executed, instantiated, and/or performed using an example processing circuitry implementation of the parent device 200 of FIG. 2 to perform channel hopping in a base frequency band. Example operation in a channel and/or in a frequency band generally includes data exchanges and/or other communication between the parent device 200 and child devices of the parent device 200. For example, data exchanges and/or other communication is performed in the normal fashion (e.g., the devices transmit data packets and/or acknowledged packets between each other and the parent device 200 transmits a timing element (e.g., a timing packet) to child devices to facilitate synchronization). In the example of FIG. 6, at block 608, the processing circuitry 202 determines whether the first time period has expired. For example, at block 608, the channel timing circuitry 206 determines whether the first time period after which to switch from the base frequency band to the alternate frequency band has expired based on one or more counters of the counter circuitry 208. Based on (e.g., in response to) the processing circuitry 202 determining that the first period has not expired (block 608: NO), the machine-readable instructions and/or the operations 600 return to block 606. Based on (e.g., in response to) the processing circuitry 202 determining that the first period has expired (block 608: YES), the machine-readable instructions and/or the operations 600 proceed to block 610.

In the illustrated example of FIG. 6, at block 610, the processing circuitry 202 tunes the interface circuitry 212 of the parent device 200 to the alternate frequency band. For example, at block 610, the communication control circuitry 204 tunes the interface circuitry 212 of the parent device 200 to the alternate frequency band and, e.g., loads PHY configuration data corresponding to the communication protocol associated with the alternate frequency band to the receiver circuitry 216. At block 612, the processing circuitry 202 operates in the alternate frequency band. For example, at block 612, the communication control circuitry 204 operates in the alternate frequency band. As described above, example operation includes data exchanges and/or other communication between the parent device 200 and child devices of the parent device 200 (e.g., the devices transmit data packets and/or acknowledged packets between each other and the parent device 200 transmits a timing element (e.g., a timing packet) to child devices to facilitate synchronization). At block 614, the processing circuitry 202 determines whether the second time period has expired. For example, at block 614, the channel timing circuitry 206 determines whether the second time period after which to switch from the alternate frequency band to the base frequency band has expired based on one or more counters of the counter circuitry 208.

In the illustrated example of FIG. 6, based on (e.g., in response to) the processing circuitry 202 determining that the second period has not expired (block 614: NO), the machine-readable instructions and/or the operations 600 return to block 612. Based on (e.g., in response to) the processing circuitry 202 determining that the second period has expired (block 614: YES), the machine-readable instructions and/or the operations 600 proceed to block 616. At block 616, the processing circuitry 202 tunes the interface circuitry 212 of the parent device 200 to the base frequency band. For example, at block 616, the communication control circuitry 204 tunes the interface circuitry 212 of the parent device 200 to the base frequency band and, e.g., loads PHY configuration data corresponding to the communication protocol associated with the base frequency band to the receiver circuitry 216.

In the illustrated example of FIG. 6, at block 618, the processing circuitry 202 determines whether to continue operating. For example, at block 618, the communication control circuitry 204 determines whether to continue operating based on whether the parent device 200 is powered. Based on (e.g., in response to) the processing circuitry 202 determining that the parent device 200 is to continue operating (block 618: YES), the machine-readable instructions and/or the operations 600 return to block 606. Based on (e.g., in response to) the processing circuitry 202 determining that the parent device 200 is not to continue operating (block 618: NO), the machine-readable instructions and/or the operations 600 terminate.

FIG. 7 is a flowchart representative of example machine-readable instructions and/or example operations 700 that may be executed, instantiated, and/or performed using an example processing circuitry implementation of the parent device 200 of FIG. 2 to perform channel hopping in a base frequency band. The example machine-readable instructions and/or the example operations 700 as described can be performed by a parent device (e.g., the parent device 200). As described above, the example machine-readable instructions and/or the example operations 700 of FIG. 7 may be executed, instantiated, and/or performed to implement block 606 of the example machine-readable instructions and/or the example operations 600 of FIG. 6. The example machine-readable instructions and/or the example operations 700 of FIG. 7 begin at block 702, at which the processing circuitry 202 tunes the interface circuitry 212 of the parent device 200 to a first channel in the base frequency band. For example, at block 702, the communication control circuitry 204 tunes the interface circuitry 212 of the parent device 200 to a first channel in the base frequency band.

In the illustrated example of FIG. 7, at block 704, the processing circuitry 202 operates in the first channel. For example, at block 704, the communication control circuitry 204 operates in the first channel. As described above, example operation includes data exchanges and/or other communication between the parent device 200 and child devices of the parent device 200 (e.g., the devices transmit data packets and/or acknowledged packets between each other and the parent device 200 transmits a timing element (e.g., a timing packet) to child devices to facilitate synchronization). At block 706, the processing circuitry 202 determines whether a first dwell time for the parent device 200 has expired. For example, at block 706, the channel timing circuitry 206 determines whether a first dwell time for the parent device 200 has expired based on one or more counters of the counter circuitry 208. Based on (e.g., in response to) the processing circuitry 202 determining that the first dwell time has not expired (block 706: NO), the machine-readable instructions and/or the operations 700 return to block 704. For example, based on (e.g., in response to) the processing circuitry 202 (e.g., the channel timing circuitry 206) determining that the first dwell time has not expired at block 706, the processing circuitry 202 (e.g., the communication control circuitry 204) may be configured to continue operating in the first channel at block 704. Based on (e.g., in response to) the processing circuitry 202 determining that the first dwell time has expired (block 706: YES), the machine-readable instructions and/or the operations 700 proceed to block 708.

In the illustrated example of FIG. 7, at block 708, the processing circuitry 202 determines whether a first data exchange in the first channel has completed. For example, at block 708, the communication control circuitry 204 determines whether a first data exchange in the first channel has completed. Based on (e.g., in response to) the processing circuitry 202 determining that the first data exchange in the first channel has not completed (block 708: NO), the machine-readable instructions and/or the operations 700 return to block 704. For example, based on (e.g., in response to) the processing circuitry 202 (e.g., the communication control circuitry 204) determining that the first data exchange in the first channel has not completed at block 708, the processing circuitry 202 (e.g., the communication control circuitry 204) may be configured to continue operating in the first channel at block 704. Based on (e.g., in response to) the processing circuitry 202 determining that the first data exchange in the first channel has completed (block 708: YES), the machine-readable instructions and/or the operations 700 proceed to block 710. In the illustrated example of FIG. 7, at block 710, the processing circuitry 202 tunes the interface circuitry 212 of the parent device 200 to a second channel in the base frequency band. For example, at block 710, the communication control circuitry 204 tunes the interface circuitry 212 of the parent device 200 to a second channel in the base frequency band.

In the illustrated example of FIG. 7, at block 712, the processing circuitry 202 determines whether a period after which the parent device 200 is to alternate dwell times has expired. For example, at block 712, the channel timing circuitry 206 determines whether a period after which the parent device 200 is to alternate dwell times has expired. Based on (e.g., in response to) the processing circuitry 202 determining that the period after which the parent device 200 is to alternate dwell times has not expired (block 712: NO), the machine-readable instructions and/or the operations 700 proceed to block 714. Based on (e.g., in response to) the processing circuitry 202 determining that the period after which the parent device 200 is to alternate dwell times has expired (block 712: YES), the machine-readable instructions and/or the operations 700 proceed to block 720.

In the illustrated example of FIG. 7, at block 714, the processing circuitry 202 operates in the second channel. For example, at block 714, the communication control circuitry 204 operates in the second channel. As described above, example operation includes data exchanges and/or other communication between the parent device 200 and child devices of the parent device 200 (e.g., the devices transmit data packets and/or acknowledged packets between each other and the parent device 200 transmits a timing element (e.g., a timing packet) to child devices to facilitate synchronization). At block 716, the processing circuitry 202 determines whether the first dwell time for the parent device 200 has expired. For example, at block 716, the channel timing circuitry 206 determines whether the first dwell time for the parent device 200 has expired based on one or more counters of the counter circuitry 208. Based on (e.g., in response to) the processing circuitry 202 determining that the first dwell time has not expired (block 716: NO), the machine-readable instructions and/or the operations 700 return to block 714. Based on (e.g., in response to) the processing circuitry 202 determining that the first dwell time has expired (block 716: YES), the machine-readable instructions and/or the operations 700 proceed to block 718.

In the illustrated example of FIG. 7, at block 718, the processing circuitry 202 determines whether a second data exchange in the second channel has completed. For example, at block 718, the communication control circuitry 204 determines whether a second data exchange in the second channel has completed. Based on (e.g., in response to) the processing circuitry 202 determining that the second data exchange in the second channel has not completed (block 718: NO), the machine-readable instructions and/or the operations 700 return to block 714. Based on (e.g., in response to) the processing circuitry 202 determining that the second data exchange in the second channel has completed (block 718: YES), the machine-readable instructions and/or the operations 700 return to the machine-readable instructions and/or the operations 600 at block 608.

In the illustrated example of FIG. 7, at block 720, based on the period after which the parent device 200 is to alternate dwell times having expired, the processing circuitry 202 utilizes a second dwell time for the parent device 200. For example, at block 720, based on the period after which the parent device 200 is to alternate dwell times having expired, the channel timing circuitry 206 utilizes a second dwell time for the parent device 200. At block 722, the processing circuitry 202 operates in the second channel. For example, at block 722, the communication control circuitry 204 operates in the second channel. As described above, example operation includes data exchanges and/or other communication between the parent device 200 and child devices of the parent device 200 (e.g., the devices transmit data packets and/or acknowledged packets between each other and the parent device 200 transmits a timing element (e.g., a timing packet) to child devices to facilitate synchronization). At block 724, the processing circuitry 202 determines whether the second dwell time for the parent device 200 has expired. For example, at block 724, the channel timing circuitry 206 determines whether the second dwell time for the parent device 200 has expired based on one or more counters of the counter circuitry 208.

In the illustrated example of FIG. 7, based on (e.g., in response to) the processing circuitry 202 determining that the second dwell time has not expired (block 724: NO), the machine-readable instructions and/or the operations 700 return to block 722. Based on (e.g., in response to) the processing circuitry 202 determining that the second dwell time has expired (block 724: YES), the machine-readable instructions and/or the operations 700 proceed to block 726. At block 726, the processing circuitry 202 determines whether a third data exchange in the second channel has completed. For example, at block 726, the communication control circuitry 204 determines whether a third data exchange in the second channel has completed. Based on (e.g., in response to) the processing circuitry 202 determining that the third data exchange in the second channel has not completed (block 726: NO), the machine-readable instructions and/or the operations 700 return to block 722. Based on (e.g., in response to) the processing circuitry 202 determining that the third data exchange in the second channel has completed (block 726: YES), the machine-readable instructions and/or the operations 700 return to the machine-readable instructions and/or the operations 600 at block 608.

FIG. 8 is a flowchart representative of example machine-readable instructions and/or example operations 800 that may be executed, instantiated, and/or performed using an example processing circuitry implementation of the child device 300 of FIG. 3 to synchronize with an example parent device. The example machine-readable instructions and/or the example operations 800 as described can be performed by a child device (e.g., the child device 300). The example machine-readable instructions and/or the example operations 800 of FIG. 8 begin at block 802, at which the processing circuitry 302 causes transmission of one or more discovery requests to one or more candidate parent devices. For example, at block 802, the communication control circuitry 304 causes transmission of one or more discovery requests to one or more candidate parent devices. Example discovery requests includes information identifying a channel to which the communication control circuitry 304 will tune the interface circuitry 312 for a predetermined period of time.

In the illustrated example of FIG. 8, at block 804, the interface circuitry 312 receives, from the one or more candidate parent devices, one or more responses to the one or more discovery requests. For example, after causing transmission of the one or more discovery requests, the communication control circuitry 304 tunes the receiver circuitry 316 to the channel identified in the discovery requests. As such, at block 804, the receiver circuitry 316 receives, from the one or more candidate parent devices, one or more responses to the one or more discovery requests on the channel identified in the one or more discovery requests. At block 806, the processing circuitry 302 selects, from the one or more candidate parent devices, a first parent device with which to synchronize. For example, at block 806, the communication control circuitry 304 selects, from the one or more candidate parent devices, a first parent device with which to synchronize based on one or more connectivity metrics between the child device 300 and the one or more candidate parent devices. The processing circuitry 302 may be configured to determine the one or more connectivity metrics based on, for example, the signal strength of each response received at block 804. Additionally or alternatively, each response may include an indication of the connectivity metric between the child device 300 and the respective parent device.

In the illustrated example of FIG. 8, at block 808, the processing circuitry 302 follows the channel hopping sequence of the first parent device in a base frequency band of the first parent device. Example operation in a channel and/or in a frequency band generally includes data exchanges and/or other communication between the child device 300 and a parent device with which the child device 300 is synchronized. For example, data exchanges and/or other communication is performed in the normal fashion (e.g., the devices transmit data packets and/or acknowledged packets between each other and the parent device with which the child device 300 is synchronized transmits a timing element (e.g., a timing packet) to the child device 300 to facilitate synchronization). At block 810, the processing circuitry 302 determines whether a first period after which the first parent device is to switch from the base frequency band to an alternate frequency band has expired. For example, at block 810, the channel timing circuitry 306 determines whether a first period after which the first parent device is to switch from the base frequency band to an alternate frequency band has expired. Based on (e.g., in response to) the processing circuitry 302 determining that the first period has not expired (block 810: NO), the machine-readable instructions and/or the operations 800 return to block 808. Based on (e.g., in response to) the processing circuitry 302 determining that the first period has expired (block 810: YES), the machine-readable instructions and/or the operations 800 proceed to block 812.

In the illustrated example of FIG. 8, at block 812, the processing circuitry 302 tunes the interface circuitry 312 of the child device 300 to the alternate frequency band. For example, at block 812, the communication control circuitry 304 tunes the interface circuitry 312 of the child device 300 to the alternate frequency band. At block 814, the processing circuitry 302 operates in the alternate frequency band. For example, at block 814, the communication control circuitry 304 operates in the alternate frequency band. As described above, example operation includes data exchanges and/or other communication between the child device 300 and a parent device with which the child device 300 is synchronized (e.g., the devices transmit data packets and/or acknowledged packets between each other and the parent device with which the child device 300 is synchronized transmits a timing element (e.g., a timing packet) to the child device 300 to facilitate synchronization). At block 816, the processing circuitry 302 determines whether a second time period after which the first parent device is to switch from the alternate frequency band to the base frequency band has expired. For example, at block 816, the channel timing circuitry 306 determines whether a second time period after which the first parent device is to switch from the alternate frequency band to the base frequency band has expired based on one or more counters of the counter circuitry 308.

In the illustrated example of FIG. 8, based on (e.g., in response to) the processing circuitry 302 determining that the second period has not expired (block 816: NO), the machine-readable instructions and/or the operations 800 return to block 814. Based on (e.g., in response to) the processing circuitry 302 determining that the second period has expired (block 816: YES), the machine-readable instructions and/or the operations 800 proceed to block 818. At block 818, the processing circuitry 302 tunes the interface circuitry 312 of the child device 300 to the base frequency band. For example, at block 818, the communication control circuitry 304 tunes the interface circuitry 312 of the child device 300 to the base frequency band.

In the illustrated example of FIG. 8, at block 820, the processing circuitry 302 determines whether to continue operating. For example, at block 820, the communication control circuitry 304 determines whether to continue operating based on whether the child device 300 is powered. Based on (e.g., in response to) the processing circuitry 302 determining that the child device 300 is to continue operating (block 820: YES), the machine-readable instructions and/or the operations 800 return to block 808. For example, after determining that the child device 300 is to continue operating at block 820, the processing circuitry 302 may be configured to follow the channel hopping sequence of the first parent device at block 808. Based on (e.g., in response to) the processing circuitry 302 determining that the child device 300 is not to continue operating (block 820: NO), the machine-readable instructions and/or the operations 800 terminate.

FIG. 9 is a flowchart representative of example machine-readable instructions and/or example operations 900 that may be executed, instantiated, and/or performed using an example processing circuitry implementation of the child device 300 of FIG. 3 to perform coordinated sampled listening with channel hopping. The example machine-readable instructions and/or the example operations 900 as described can be performed by a child device (e.g., the child device 300). The example machine-readable instructions and/or the example operations 900 of FIG. 9 begin at block 902, at which the processing circuitry 302 places the child device 300 into a sleep mode of operation. For example, at block 902, the communication control circuitry 304 places the child device 300 into a sleep mode of operation by turning off the interface circuitry 312.

In the illustrated example of FIG. 9, at block 904, the processing circuitry 302 determines a time after which to place the device into a wake mode of operation. For example, at block 904, the channel timing circuitry 306 determines a time after which to place the device into a wake mode of operation. At block 906, the processing circuitry 302 determines whether the time has occurred. For example, at block 906, the channel timing circuitry 306 determines whether the time has occurred based on one or more counters of the counter circuitry 308. Based on (e.g., in response to) the processing circuitry 302 determining that the time has not occurred (block 906: NO), the machine-readable instructions and/or the operations 900 return to block 906. Based on (e.g., in response to) the processing circuitry 302 determining that the time has occurred (block 906: YES), the machine-readable instructions and/or the operations 900 proceed to block 908.

In the illustrated example of FIG. 9, at block 908, the processing circuitry 302 tunes the interface circuitry 312 of the child device 300 to a channel in which a parent device is expected to be operating, the child device 300 synchronized with the parent device. For example, at block 908, the communication control circuitry 304 tunes the interface circuitry 312 of the child device 300 to a channel in which a parent device is expected to be operating during a wake period of the child device 300, the child device 300 synchronized with the parent device. At block 910, the processing circuitry 302 operates in the channel. For example, at block 910, the communication control circuitry 204 operates in the channel during the wake period of the child device 300. As described above, example operation includes data exchanges and/or other communication between the child device 300 and a parent device with which the child device 300 is synchronized (e.g., the devices transmit data packets and/or acknowledged packets between each other and the parent device with which the child device 300 is synchronized transmits a timing element (e.g., a timing packet) to the child device 300 to facilitate synchronization). Examples of the wake period described in connection with blocks 908 and 910 are described above with respect to FIG. 5. At block 912, the processing circuitry 302 determines whether a dwell time for the parent device has expired. For example, at block 912, the channel timing circuitry 306 determines whether the dwell time for the parent device has expired based on one or more counters of the counter circuitry 308.

In the illustrated example of FIG. 9, based on (e.g., in response to) the processing circuitry 302 determining that the dwell time has not expired (block 912: NO), the machine-readable instructions and/or the operations 900 return to block 910. Based on (e.g., in response to) the processing circuitry 302 determining that the dwell time has expired (block 912: YES), the machine-readable instructions and/or the operations 900 proceed to block 914. At block 914, the processing circuitry 302 determines whether a data exchange in the channel has completed. For example, at block 914, the communication control circuitry 304 determines whether a data exchange in the channel has completed. Based on (e.g., in response to) the processing circuitry 302 determining that the data exchange in the channel has not completed (block 914: NO), the machine-readable instructions and/or the operations 900 return to block 910. Based on (e.g., in response to) the processing circuitry 302 determining that the data exchange in the channel has completed (block 914: YES), the machine-readable instructions and/or the operations 900 proceed to block 916.

In the illustrated example of FIG. 9, at block 916, the processing circuitry 302 determines whether to continue operating. For example, at block 916, the communication control circuitry 304 determines whether to continue operating based on whether the child device 300 is powered. Based on (e.g., in response to) the processing circuitry 302 determining that the child device 300 is to continue operating (block 916: YES), the machine-readable instructions and/or the operations 900 return to block 902. For example, after determining that the child device 300 is to continue operating at block 916, the processing circuitry 302 may be configured to place the child device 300 into a sleep mode of operation at block 902. Based on (e.g., in response to) the processing circuitry 302 determining that the child device 300 is not to continue operating (block 916: NO), the machine-readable instructions and/or the operations 900 terminate.

FIG. 10 is a flowchart representative of example machine-readable instructions and/or example operations 1000 that may be executed, instantiated, and/or performed using an example processing circuitry implementation of the parent device 200 of FIG. 2 to utilize an alternate frequency band to assist in parent selection for a child device. The example machine-readable instructions and/or the example operations 1000 as described can be performed by a first parent device (e.g., the parent device 200) that is initially synchronized with a child device. The example machine-readable instructions and/or the example operations 1000 of FIG. 10 begin at block 1002, at which the processing circuitry 202 determines a connectivity metric for a child device synchronized with a first parent device. For example, at block 1002, the communication control circuitry 204 determines a connectivity metric for a child device synchronized with the parent device 200. In the example of FIG. 10, at block 1002, the communication control circuitry 204 determines a connectivity metric for a child device based on a communication from the child device in a base frequency band (e.g., the sub-1 GHz frequency band) of the parent device 200. Example connectivity metrics include a single strength metric, an RSSI value, a BER value, and/or a LQI value.

In the illustrated example of FIG. 10, at block 1004, the processing circuitry 202 causes transmission of the connectivity metric to a second parent device with which the child device is not synchronized. For example, at block 1004, the communication control circuitry 204 causes transmission of the connectivity metric to a second parent device with which the child device is not synchronized. In the example of FIG. 10, at block 1004, the communication control circuitry 204 causes transmission of the connectivity metric to the second parent device in an alternate frequency band (e.g., the 2.4 GHz frequency band) of the parent device 200. In some examples, at block 1004, the communication control circuitry 204 includes with the connectivity metric, a request for the second parent device to determine a second connectivity metric representative of the connectivity between the second parent device and the child device. At block 1006, the processing circuitry 202 determines whether a first communication has been received (e.g., from the second parent device) indicating that the child device has stronger connectivity to the second parent device than the first parent device. For example, at block 1006, the communication control circuitry 204 determines whether a first communication has been received indicating that the child device has stronger connectivity to the second parent device than the first parent device. For example, the receiver circuitry 216 may receive the first communication in the alternate frequency band (e.g., the 2.4 GHz frequency band) of the parent device 200.

In the illustrated example of FIG. 10, based on (e.g., in response to) the processing circuitry 202 determining that a first communication has not been received (block 1006: NO), the first communication indicating that the child device has stronger connectivity to the second parent device than the first parent device, the machine-readable instructions and/or the operations 1000 return to block 1002. Thus, the first parent device may be configured to maintain synchronization with the child device based on (e.g., in response to) not receiving a response from the second parent device (e.g., within a threshold amount of time). Additionally or alternatively, the first parent device may be configured to maintain synchronization with the child device based on (e.g., in response to) receiving a first communication from the second parent device indicating that the second parent device has a worse connection with the child device than the first child device. Based on (e.g., in response to) the processing circuitry 202 determining that a first communication has been received (block 1006: YES), the first communication indicating that the child device has stronger connectivity to the second parent device than the first parent device, the machine-readable instructions and/or the operations 1000 proceed to block 1008.

In the illustrated example of FIG. 10, at block 1008, the processing circuitry 202 causes transmission of a second communication to the child device, the second communication indicating that the child device is to desynchronize with the first parent device and synchronize with the second parent device. For example, at block 1008, the communication control circuitry 204 causes transmission of a second communication to the child device, the second communication indicating that the child device is to desynchronize with the first parent device and synchronize with the second parent device. In the example of FIG. 10, at block 1008, the communication control circuitry 204 causes transmission of the second communication to the child device in the base frequency band (e.g., the sub-1 GHz frequency band) of the parent device 200. At block 1010, the processing circuitry 202 determines whether to continue operating. For example, at block 1010, the communication control circuitry 204 determines whether to continue operating based on whether the parent device 200 is powered. Based on (e.g., in response to) the processing circuitry 202 determining that the parent device 200 is to continue operating (block 1010: YES), the machine-readable instructions and/or the operations 1000 return to block 1002. Based on (e.g., in response to) the processing circuitry 202 determining that the parent device 200 is not to continue operating (block 1010: NO), the machine-readable instructions and/or the operations 1000 terminate.

FIG. 11 is a flowchart representative of example machine-readable instructions and/or example operations 1100 that may be executed, instantiated, and/or performed using an example processing circuitry implementation of the parent device 200 of FIG. 2 to utilize an alternate frequency band to assist in parent selection for a child device. The example machine-readable instructions and/or the example operations 1100 as described can be performed by a second parent device (e.g., the parent device 200) that is not initially synchronized with a child device. The example machine-readable instructions and/or the example operations 1100 of FIG. 11 begin at block 1102, at which the interface circuitry 212 receives a first connectivity metric representative of first connectivity between a first parent device and a child device synchronized with the first parent device. For example, at block 1102, the receiver circuitry 216 receives a first connectivity metric representative of first connectivity between a first parent device and a child device synchronized with the first parent device. In the example of FIG. 11, at block 1102, the receiver circuitry 216 receives the first connectivity metric in an alternate frequency band (e.g., the 2.4 GHz frequency band) of the parent device 200.

In the illustrated example of FIG. 11, at block 1104, the processing circuitry 202 detects, at a second parent device, a first communication from the child device, the child device unsynchronized with the second parent device. For example, at block 1104, the communication control circuitry 204 detects, at a second parent device, a first communication from the child device, the child device unsynchronized with the second parent device. In the example of FIG. 11, at block 1106, the communication control circuitry 204 detects the first communication from the child device in a base frequency band (e.g., the sub-1 GHz frequency band) of the parent device 200. At block 1106, the processing circuitry 202 determines a second connectivity metric for the child device, the second connectivity metric representative of second connectivity between the second parent device and the child device. For example, at block 1106, the communication control circuitry 204 determines a second connectivity metric for the child device, the second connectivity metric representative of second connectivity between the second parent device and the child device. In the example of FIG. 11, the communication control circuitry 204 may be configured to determine the second connectivity metric based on a signal strength and/or other characteristic of the first communication detected at block 1104.

In the illustrated example of FIG. 11, at block 1108, the processing circuitry 202 determines whether the second connectivity between the second parent device and the child device is better than the first connectivity between the first parent device and the child device. For example, at block 1108, the communication control circuitry 204 determines whether the second connectivity between the second parent device and the child device is better than the first connectivity between the first parent device and the child device. Based on (e.g., in response to) the processing circuitry 202 determining that the second connectivity is not better than the first connectivity (block 1108: NO), the machine-readable instructions and/or the operations 1100 return to block 1102. For example, based on the processing circuitry 202 determining that the second connectivity is not better than the first connectivity, the parent device 200 may be configured to refrain from attempting to synchronize with the child device (e.g., for a threshold amount of time). Based on (e.g., in response to) the processing circuitry 202 determining that the second connectivity is better than the first connectivity (block 1108: YES), the machine-readable instructions and/or the operations 1100 proceed to block 1110. For example, in blocks 1110, 1112, and 1114, the parent device 200 attempts to synchronize with the child device based on (e.g., in response to) determining that the second connectivity is better than the first connectivity.

In the illustrated example of FIG. 11, at block 1110, the processing circuitry 202 causes transmission of a second communication to the first parent device, the second communication indicating that the second parent device has better connectivity with the child device than the first parent device. For example, at block 1110, the communication control circuitry 204 causes transmission of a second communication to the first parent device, the second communication indicating that the second parent device has better connectivity with the child device than the first parent device. In the example of FIG. 11, at block 1110, the communication control circuitry 204 causes transmission of the second communication to the first parent device in the alternate frequency band (e.g., the 2.4 GHz frequency band) of the parent device 200. In some examples, the second communication transmitted by the parent device 200 may include an indication of the second connectivity metric and/or an identification of the child device.

In the illustrated example of FIG. 11, at block 1112, the interface circuitry 212 receives a discovery request from the child device. For example, at block 1112, the receiver circuitry 216 receives a discovery request from the child device. In the example of FIG. 11, at block 1112, the receiver circuitry 216 receives the discovery request from the child device in the base frequency band (e.g., the sub-1 GHz frequency band) of the parent device 200. In some examples, the discovery request received at block 1112 may include an indication of the first parent device. At block 1114, the processing circuitry 202 causes transmission of a response to the discovery request. For example, the communication control circuitry 204 causes transmission of a response to the discovery request. As described above, example discovery request identify a specific channel to which interface circuitry of the child device will be tuned for a predetermined period of time. As such, at block 1114, the communication control circuitry 204 causes transmission of the response to the discovery request in the channel identified in the discovery request. For example, the identified channel is in the base frequency band of the parent device 200 (e.g., the same band in which the discovery request was received at block 1112).

In the illustrated example of FIG. 11, at block 1116, the processing circuitry 202 determines whether to continue operating. For example, at block 1116, the communication control circuitry 204 determines whether to continue operating based on whether the parent device 200 is powered. Based on (e.g., in response to) the processing circuitry 202 determining that the parent device 200 is to continue operating (block 1116: YES), the machine-readable instructions and/or the operations 1100 return to block 1102. Based on (e.g., in response to) the processing circuitry 202 determining that the parent device 200 is not to continue operating (block 1116: NO), the machine-readable instructions and/or the operations 1100 terminate.

FIG. 12 is a flowchart representative of example machine-readable instructions and/or example operations 1200 that may be executed, instantiated, and/or performed using an example processing circuitry implementation of the child device 300 of FIG. 3 to select a parent device. The example machine-readable instructions and/or the example operations 1200 as described can be performed by a child device (e.g., the child device 300). The example machine-readable instructions and/or the example operations 1200 of FIG. 12 begin at block 1202, at which the interface circuitry 312 receives a communication indicating that a first parent device with which a child device is unsynchronized has better connectivity to the child device than a second parent device with which the child device is synchronized. For example, at block 1202, the receiver circuitry 316 receives a communication indicating that a first parent device with which the child device 300 is unsynchronized has better connectivity to the child device 300 than a second parent device with which the child device 300 is synchronized. In some examples, the communication received at block 1202 includes an indication of the first parent device and/or an indication of one or more connectivity metrics. As described with respect to FIG. 10, the child device 300 may receive the communication from the second parent device. Alternatively, in some examples, the child device 300 may receive the communication from the first parent device.

In the illustrated example of FIG. 12, at block 1204, the processing circuitry 302 causes transmission of a discovery request to the first parent device. For example, at block 1204, the communication control circuitry 304 causes transmission of a discovery request to the first parent device. In some examples, the discovery request may include an indication of the second parent device and/or an indication of a connectivity metric. In the example of FIG. 12, at block 1204, the communication control circuitry 304 causes transmission of the discovery request in the base frequency band. The example discovery requests identifies a specific channel to which the interface circuitry 312 of the child device 300 will be tuned for a predetermined period of time. At block 1206, the interface circuitry 312 receives a response to the discovery request from the first parent device. For example, at block 1206, the receiver circuitry 316 receives a response to the discovery request from the first parent device. In the example of FIG. 12, at block 1206, the receiver circuitry 316 receives the response to the discovery request in the base frequency band (e.g., the same band in which the discovery request was transmitted at block 1204).

In the illustrated example of FIG. 12, at block 1208, the processing circuitry 302 determines whether to continue operating. For example, at block 1208, the communication control circuitry 304 determines whether to continue operating based on whether the child device 300 is powered. Based on (e.g., in response to) the processing circuitry 302 determining that the child device 300 is to continue operating (block 1208: YES), the machine-readable instructions and/or the operations 1200 return to block 1202. Based on (e.g., in response to) the processing circuitry 302 determining that the child device 300 is not to continue operating (block 1208: NO), the machine-readable instructions and/or the operations 1200 terminate.

As illustrated in FIGS. 10-12, because parent devices support multiple frequency bands, parent devices can improve network operation. As such, using the 2.4 GHz frequency band, parent devices can exchange information about child devices and/or other network details useful for operation of sub-1 GHz networks. For example, a first parent device (e.g., the first dual band router 104A) can inform other parent devices (e.g., the second dual band router 104B) about any other device transmissions the first parent device has heard in the sub-1 GHz frequency band along with the received connectivity metrics (e.g., an RSSI value, a BER value, and/or a LQI value) for the device transmissions. As such, if a first parent device identifies a synchronized child device that has a first connectivity metric that is worse than a second connectivity metric between the synchronized child device and a second parent, then the first parent device can inform the synchronized child device of the availability of the second parent device. Additionally or alternatively, if a first parent device identifies that a first connectivity metric corresponding to a child device, and reported to the first parent device by a second parent device, is better than a second connectivity metric between the child device and the second parent device (the second parent device synchronized with the child device), then the first parent device can inform the second parent device that the child device has stronger connectivity to the first parent device than the second parent device. As such, the second parent device can inform the child device of the availability of the first parent device. After being notified of the availability of another parent device with stronger connectivity to the child device, the child device can initiate a new discovery request to target and join the other parent device if the child device chooses.

FIG. 13 is a block diagram of an example processing circuitry platform 1300 structured to execute and/or instantiate the example machine-readable instructions and/or the example operations of FIGS. 6, 7, 10, and/or 11 to implement the parent device 200 of FIG. 2. The processing circuitry platform 1300 can be, for example, a server, a personal computer, a workstation, a self-learning machine (e.g., a neural network), a mobile device (e.g., a cell phone, a smart phone, a tablet such as an iPad1M), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The processing circuitry platform 1300 of the illustrated example includes processing circuitry 1312. The processing circuitry 1312 of the illustrated example is hardware. For example, the processing circuitry 1312 can be implemented by one or more integrated circuits, logic circuits, FPGAs, microprocessors, CPUs, GPUs, DSPs, and/or microcontrollers from any desired family or manufacturer. The processing circuitry 1312 may be implemented by one or more semiconductor based (e.g., silicon based) devices. In this example, the processing circuitry 1312 implements the example communication control circuitry 204, the example channel timing circuitry 206, and the example counter circuitry 208.

The processing circuitry 1312 of the illustrated example includes a local memory 1313 (e.g., a cache, registers, etc.). The processing circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. In this example, one or more of the volatile memory 1314 or the non-volatile memory 1316 implements the example memory 218. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The processing circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCie) interface.

In the illustrated example, one or more input devices 1322 are connected to the interface circuitry 1320. The input device(s) 1322 permit(s) a user (e.g., a human user, a machine user, etc.) to enter data and/or commands into the processing circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 1320 implements the example antenna 210, the example transmitter circuitry 214, and the example receiver circuitry 216.

The processing circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1332, which may be implemented by the machine-readable instructions of FIGS. 6, 7, 10, and/or 11, may be stored in the mass storage device 1328, in the volatile memory 1314, in the non-volatile memory 1316, and/or on at least one non-transitory computer-readable storage medium such as a CD or DVD which may be removable.

FIG. 14 is a block diagram of an example processing circuitry platform 1400 structured to execute and/or instantiate the example machine-readable instructions and/or the example operations of FIGS. 8, 9, 12, and/or 20 to implement the child device 300 of FIG. 3. The processing circuitry platform 1400 can be, for example, a server, a personal computer, a workstation, a self-learning machine (e.g., a neural network), a mobile device (e.g., a cell phone, a smart phone, a tablet such as an iPad®), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The processing circuitry platform 1400 of the illustrated example includes processing circuitry 1412. The processing circuitry 1412 of the illustrated example is hardware. For example, the processing circuitry 1412 can be implemented by one or more integrated circuits, logic circuits, FPGAs, microprocessors, CPUs, GPUs, DSPs, and/or microcontrollers from any desired family or manufacturer. The processing circuitry 1412 may be implemented by one or more semiconductor based (e.g., silicon based) devices. In this example, the processing circuitry 1412 implements the example communication control circuitry 304, the example channel timing circuitry 306, and the example counter circuitry 308.

The processing circuitry 1412 of the illustrated example includes a local memory 1413 (e.g., a cache, registers, etc.). The processing circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. In this example, one or more of the volatile memory 1414 or the non-volatile memory 1416 implements the example memory 318. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The processing circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, a Peripheral Component Interconnect Express (PCie) interface, and/or any other wired or wireless interface, e.g., according to an IEEE standard, such as an interface capable of communicating according to the 2.4 GHz ISM band.

In the illustrated example, one or more input devices 1422 are connected to the interface circuitry 1420. The input device(s) 1422 permit(s) a user (e.g., a human user, a machine user, etc.) to enter data and/or commands into the processing circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 1420 implements the example antenna 310, the example transmitter circuitry 314, and the example receiver circuitry 316.

The processing circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1432, which may be implemented by the machine-readable instructions of FIGS. 8, 9, 12, and/or 20, may be stored in the mass storage device 1428, in the volatile memory 1414, in the non-volatile memory 1416, and/or on at least one non-transitory computer-readable storage medium such as a CD or DVD which may be removable.

FIG. 15 is a block diagram of an example implementation of the processing circuitry 1312 of FIG. 13 and/or the processing circuitry 1412 of FIG. 14. In this example, the processing circuitry 1312 of FIG. 13 and/or the processing circuitry 1412 of FIG. 14 is/are implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 6, 7, 8, 9, 10, 11, 12, and/or 20 to effectively instantiate the circuitry of FIGS. 2 and/or 3 as logic circuits to perform operations corresponding to those machine-readable instructions. In some such examples, the circuitry of FIGS. 2 and/or 3 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions and/or operations represented by the flowcharts of FIGS. 6, 7, 8, 9, 10, 11, 12, and/or

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCie bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (LI) cache that may be split into an LI data cache and an LI instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1314, 1316 of FIG. 13 and/or the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry 1516 (sometimes referred to as an ALU), a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those described herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the processing circuitry 1312 of FIG. 13 and/or the processing circuitry 1412 of FIG. 14. In this example, the processing circuitry 1312 of FIG. 13 and/or the processing circuitry 1412 of FIG. 14 is/are implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowchart(s) of FIGS. 6, 7, 8, 9, 10, 11, 12, and/or 20 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6, 7, 8, 9, 10, 11, 12, and/or 20. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6, 7, 8, 9, 10, 11, 12, and/or 20. As such, the FPGA circuitry 1600 may be configured and/or structured to effectively instantiate some or all of the operations/functions corresponding to the machine-readable instructions of the flowchart(s) of FIGS. 6, 7, 8, 9, 10, 11, 12, and/or 20 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 6, 7, 8, 9, 10, 11, 12, and/or 20 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 6, 7, 8, 9, 10, 11, 12, and/or 20 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCie controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processing circuitry 1312 of FIG. 13 and/or the processing circuitry 1412 of FIG. 14, many other approaches are contemplated. For example, FPGA circuitry may include an on-board CPU, such as one or more of the example CPU 1620 of FIG. 16. Therefore, the processing circuitry 1312 of FIG. 13 and/or the processing circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowchart(s) of FIGS. 6, 7, 8, 9, 10, 11, 12, and/or 20 to perform first operation(s)/function(s), the FPGA circuitry 1600 of FIG. 16 may be configured and/or structured to perform second operation(s)/function(s) corresponding to a second portion of the machine-readable instructions represented by the flowcharts of FIGS. 6, 7, 8, 9, 10, 11, 12, and/or 20, and/or an ASIC may be configured and/or structured to perform third operation(s)/function(s) corresponding to a third portion of the machine-readable instructions represented by the flowcharts of FIGS. 6, 7, 8, 9, 10, 11, 12, and/or 20.

It should be understood that some or all of the circuitry of FIGS. 2 and/or 3 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIGS. 2 and/or 3 may be instantiated, for example, in one or more threads executing concurrently and/or in series. For example, the microprocessor 1500 of FIG. 15 may execute machine-readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIGS. 2 and/or 3 may be implemented within one or more virtual machines and/or containers executing on the microprocessor 1500 of FIG. 15.

In some examples, the processing circuitry 1312 of FIG. 13 and/or the processing circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the processing circuitry 1312 of FIG. 13 and/or the processing circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16s) in still yet another package.

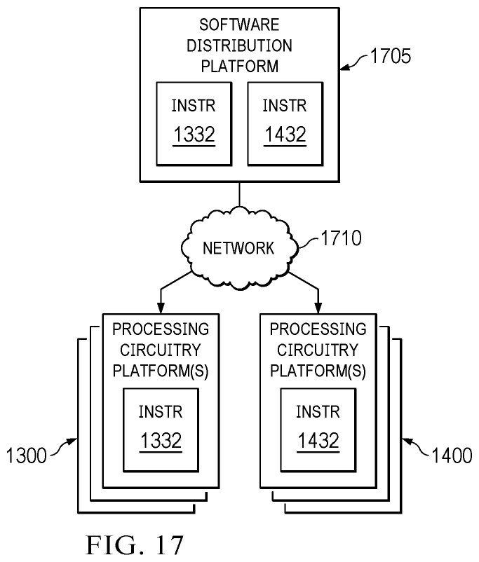

A block diagram illustrating an example software distribution platform 1705 to distribute software such as the example machine-readable instructions 1332 of FIG. 13 and/or the example machine-readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine-readable instructions 1332 of FIG. 13 and/or the example machine-readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine-readable instructions 1332 and/or the machine-readable instructions 1432, which may correspond to the example machine-readable instructions of FIGS. 6, 7, 8, 9, 10, 11, 12, and/or 20, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 and/or the machine-readable instructions 1432 from the software distribution platform 1705. For example, the software, which may correspond to the example machine-readable instructions of FIGS. 6, 7, 10, and/or 11, may be downloaded to the example processing circuitry platform 1300, which is to execute the machine-readable instructions 1332 to implement the parent device 200. Additionally, for example, the software, which may correspond to the example machine-readable instructions of FIGS. 8, 9, 12, and/or 20, may be downloaded to the example processing circuitry platform 1400, which is to execute the machine-readable instructions 1432 to implement the child device 300. In some examples, one or more servers of the software distribution platform 1705 periodically offer, transmit, and/or force updates to the software (e.g., the example machine-readable instructions 1332 of FIG. 13 and/or the example machine-readable instructions 1432 of FIG. 14) to ensure improvements, patches, updates, etc., are distributed and applied to the software at the end user devices. Although referred to as software above, the distributed “software” could alternatively be firmware.

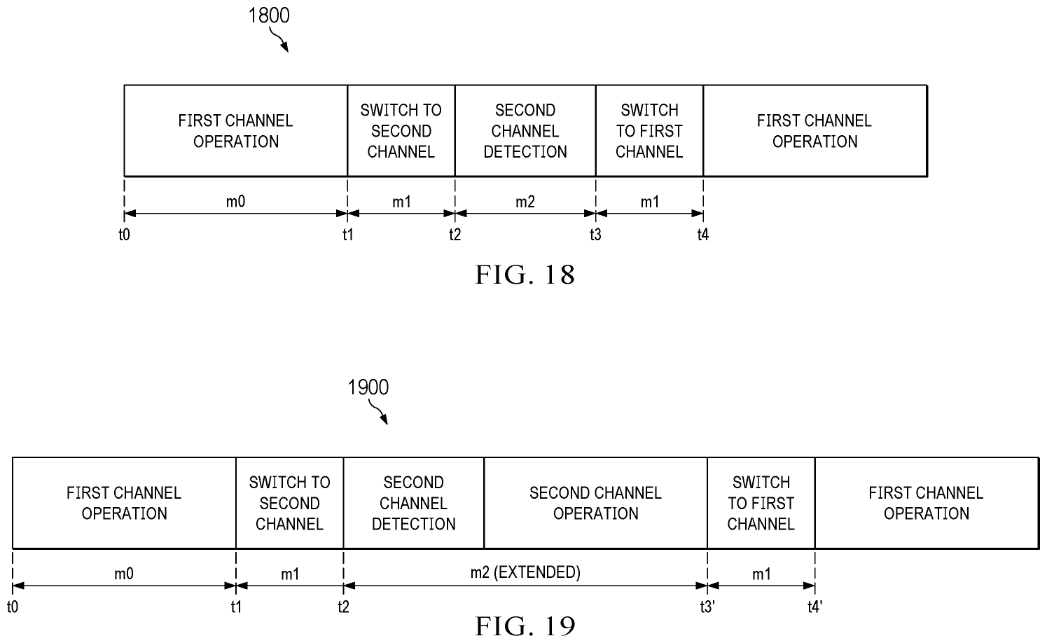

FIG. 18 is a timing diagram 1800 illustrating example time multiplexing of receiver circuitry 312 of a child device 300. In the example of FIG. 18, an example child device (which may be a child device 300, as described above herein) may listen to first and second channels in a time-multiplexed manner determined to maximize an amount of time spent listening to the first channel while maintaining a probability of detecting communication on the second channel greater than a threshold probability. While described herein in the context of the child device 300, interface circuitry 312, and receiver circuitry 316, in various examples similar approaches may be suitable for application by the parent device 200, interface circuitry 212, and receiver circuitry 216, or any other network node or device. For example, while described herein as the child device 300 performing time multiplexing to receive communication from the parent device 200, the time multiplexing described herein may instead be performed by a parent device 200 to receive communication from the child device 300 (or another device).

As described above, a network node operates according to the first communication protocol starting at time t0 for a time duration m0 (e.g. about 7 ms to about 9 ms). At time t1, the child device switches or transitions from listening to a first channel associated with a first communication protocol to listening to a second channel associated with a second communication protocol. In some examples, the transition, or retuning and reprogramming of a radio or other circuitry of the child device, consumes an amount of time m1. Beginning at time t2, the child device listens to the second channel for a period of time m2 to attempt to detect communication associated with the second communication protocol, such as by detecting a preamble associated with the second communication protocol. In some examples, period of time m2 has a first value (e.g., about 1200 μs) for operational circumstances in which communication is not detected on the second channel during the period of time m2. In some examples, period of time m2 may be extended from the first value to a second value for operational circumstances in which communication is detected on the second channel. In some examples, the first value is determined based on a preamble duration of an advertisement packet of the second communication protocol communicated on the second channel. In some examples, the second value is determined based on a packet duration, or an amount of time for receiving a packet, such as an advertisement packet of the second communication protocol. In some examples, period of time m2 may be extended until after one or more packets are exchanged (e.g., in one or more channels associated with the second communication protocol). At the expiration of period of time m2, at time t3, the child device switches or transitions from listening to the second channel to listening to a channel associated with the first communication protocol, such as the first channel. This process of switching between listening to the first and second channels alternatingly may then repeat, as shown in FIG. 18.

Such an example in which communication associated with the second communication protocol is detected during period of time m2 is shown in FIG. 19 by the timing diagram 1900. As shown by FIG. 19 in comparison to FIG. 18, the period of time m2 is extended to facilitate the child device receiving an advertisement packet during period of time m2 and possibly additional packets associated with the second communication protocol. In some examples, m2 as shown in FIG. 19 may be about 2 ms to about 3 ms in length (or longer), compared to about 1200 μs in the example shown in FIG. 18 in the operational circumstance in which the child device does not detect communication associated with the second communication protocol is detected during period of time m2. Subsequent to receiving the advertisement packet, the child device may retune the receiver circuitry to a frequency of another channel (e.g., a third channel) associated with the second protocol to receive a data packet according to the second protocol. In some examples, the data packet includes one or more instructions, operations, or functions for the child device to perform. Responsive to receipt of the data packet, the child device may execute the instructions and/or perform the operations of functions. Based on the instructions, operations, or functions the child device may communicate with another device (e.g., implement control over another device), manipulate settings or programming of the child device, or perform any other suitable actions, the scope of which is not limited herein.

Returning to FIG. 18, in some embodiments, the first protocol and second protocol operations illustrated in FIG. 18 corresponds to Zigbee® and BLE, respectively. In some embodiments, the duration of period of time m1 may be about 400 μs and the duration of period of time m2 may be about 1200 μs, and period of time m0 may be between about 7 ms and about 9 ms.

In some embodiments, switching from first protocol operation to second protocol operation during period of time m1 (between times t1 and t2) involves retuning a receiver circuitry (e.g., 216, 316) of a network node (e.g., 200, 300) from a first channel associated with the first communication protocol to a second channel associated with the second communication protocol, and loading PHY configuration data corresponding to the second communication protocol to the receiver circuitry of the network node, e.g., to communicate via the second channel.

In some embodiments, switching from second protocol operation to first protocol operation during period of time m1 (between times t3 and t4) involves retuning the receiver circuitry of a network node from the second channel to a channel (e.g., the first channel or another channel) associated with the first communication protocol, and loading PHY configuration data corresponding to the first communication protocol to the receiver of the network node, e.g., to communicate via the second channel.

Some communication protocols, such as BLE, implement, e.g., sequential packet retransmission in multiple channels, (such as in BLE advertisement channels 37, then 38, then 39). Some embodiments may leverage such a feature to detect operation in such type of communication protocol while maximizing operation time in another communication protocol (e.g., Zigbee®, Thread®). For example, in some embodiments, instead of detecting communications in the second communication protocol by detecting a preamble associated with the second communication protocol (e.g., as described with respect to FIG. 18), some embodiments perform energy detection in a channel associated with the second communication protocol (e.g., channel 37 of BLE) without attempting to detect a preamble or packet associated with the second communication protocol. Upon detection of energy, the device can then monitor the channel where retransmission would be expected according to such communication protocol (e.g., channel 38 and/or channel 39 of BLE). Upon detection of a packet in such channel where retransmission was expected (e.g., channel 38 or 39 of BLE), some embodiments continue operating in such protocol (e.g., BLE), e.g., to receive one or more, e.g., data packets. By using energy detection instead of attempting to detect a preamble, some embodiments advantageously avoid the overhead of loading PHY configuration data to the receiver circuitry associated with the network node to receive packets associated with the second communication protocol. By using energy detection instead of attempting to detect a preamble, some embodiments advantageously can detect communication even if the detection begins in the middle of a packet reception (since energy detected may still reflect that communication is taking place, even though a preamble of a packet may have only been partially captured by the receiver circuitry).

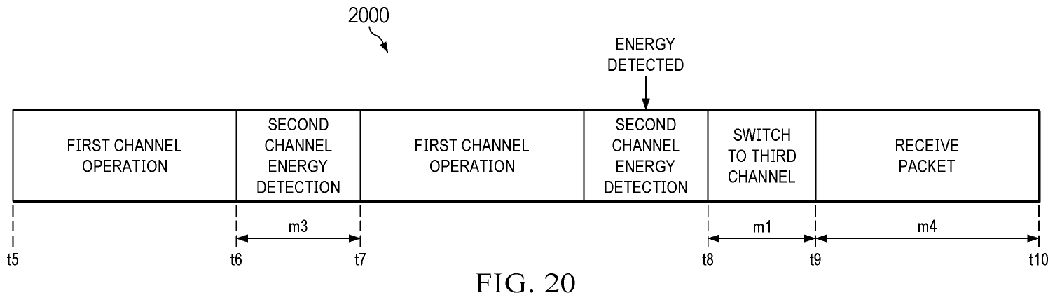

FIG. 20 is a timing diagram 2000 illustrating example time multiplexing of receiver circuitry 312 of a child device 300 using energy detection. In the example of FIG. 20, an example child device (which may be a child device 300, as described above herein) may listen to first and second communication protocols in a time-multiplexed manner determined to maximize an amount of time spent listening to the first communication protocol while maintaining a probability of detecting communication on the second communication protocol greater than a threshold probability. While described herein in the context of the child device 300, interface circuitry 312, and receiver circuitry 316, in various examples similar approaches may be suitable for application by the parent device 200, interface circuitry 212, and receiver circuitry 216, or any other network node or device. For example, while described herein as the child device 300 performing time multiplexing to receive communication from the parent device 200, the time multiplexing described herein may instead be performed by a parent device 200 to receive communication from the child device 300 (or another device).

As described above, the child device communicates via the first communication protocol from time t5 to time t6 using a first channel associated with the first communication protocol. At time t6, the child device begins performing energy detection in a second channel associated with a second communication protocol, which may involve retuning the frequency of the receiver circuitry to that of the second channel (not illustrated in FIG. 20, but such transition time may be relatively small, and may be negligible). In some examples, the child device performs the energy detection without loading PHY configuration data corresponding to the second communication protocol to the receiver circuitry of the network node. The period of time m3 (between time t6 and time t7) may be between 400 μs and 500 μs.

Responsive to not detecting energy on the second channel, at time t2 the child device continues listening for communication on the first channel, which may involve retuning the frequency of the receiver to that of a channel associated with the first communication protocol (not illustrated in FIG. 20, but such transition time may be relatively small, and may be negligible), but without loading PHY configuration data corresponding to the first communication protocol to the receiver of the network node (since the receiver is already configured with such PHY configuration data). This operation may repeat until energy is detected on the second channel.

Responsive to energy being detected on the second channel, beginning at time t8, the child device loads PHY configuration data corresponding to the second communication protocol to the receiver circuitry of the child device (which may take about 400 μs) and switches or transitions to listening, at time t9, to a third channel associated with the second communication protocol for a time period m4. In some examples, the third channel is selected from among a group of channels (sequential or nonsequential) on which advertisement packets according to the second communication protocol are transmitted sequentially, or back to back. The child device may continue listening on the third channel for a duration of time (e.g., about 1 ms to about 3 ms, such as 1.2 ms to receive a packet, or up to about 3 seconds, for example, to perform a multi-packet communication exchange) determined according to the second communication protocol, such as a duration of time for receiving an advertisement packet via the third channel or a duration of performing a communication exchange involving multiple packets with another device.

Responsive to receiving the advertisement packet during the time period m4, at time t10, the child device may return to listening to the first communication protocol, or may continue operating according to the second communication protocol, such as by listening to a fourth channel (e.g., a data channel) specified according to the second communication protocol and/or the advertisement packet, such as to receive a data packet.

In some embodiments, the first protocol and second protocol operations illustrated in FIG. 20 corresponds to Zigbee® and BLE, respectively. In some embodiments, the duration of period of time m3 may be about 400 μs, the duration of period of time m4 may be about 1200 μs, and the duration of period of time m0 may be between about 7 ms and about 9 ms.

In some embodiments, such as in some embodiments in which the second communication protocol is BLE, the second channel may be channel 37 associated with BLE and the fourth channel may be channel 38 or channel 39 associated with BLE standard. In some embodiments, the second channel may be channel 38 associated with BLE and the fourth channel may be channel 39 associated with BLE standard.

Compared to the approach illustrated in FIG. 18, the approach illustrated in FIG. 20 advantageously spends substantially less time not operating according to the first communication protocol. For example, when m0 is 9 ms, m1 is about 400 μs, m2 is about 1200 μs, and m3 is about 450 μs, the approach illustrated in FIG. 20 spends about 450 μs not monitoring the first communication protocol for every 9 ms of monitoring of the first communication protocol, versus 2 ms spent when operating according to FIG. 18.

FIG. 21 is a flowchart representative of example machine-readable instructions and/or example operations 2100 that may be executed, instantiated, and/or performed using an example processing circuitry implementation of the child device 300 of FIG. 3 to perform time multiplexed packet detection. While described herein in the context of the child device 300, interface circuitry 312, and receiver circuitry 316, in various examples similar approaches may be suitable for application by the parent device 200, interface circuitry 212, and receiver circuitry 216, or any other network node or device. For example, while described herein as the child device 300 performing time multiplexing to receive communication from the parent device 200 (or another device), the time multiplexing described herein may instead be performed by a parent device 200 to receive communication from the child device 300 (or another device).

The example machine-readable instructions and/or the example operations 2100 as described can be performed by a child device (e.g., the child device 300). The example machine-readable instructions and/or the example operations 2100 of FIG. 21 begin at block 2102, at which the processing circuitry 302 controls the child device 300 to listen, via receiver circuitry, to a first portion (e.g., associated with a first communication protocol, such as Zigbee® or Thread®) of a frequency band for a first amount of time. For example, at block 2002, the communication control circuitry 304 controls the child device 300 to listen to the first portion, or channel, by tuning the interface circuitry 312 (e.g., the receiver circuitry 316) to the first frequency, which is associated with the first channel and the first communication protocol and loading, if necessary, PHY configuration data corresponding to the first communication protocol to the receiver circuitry. In some examples, the first amount of time may be equal to time period m0 (e.g., between about 7 ms and about 9 ms).

In the illustrated example of FIG. 21, at block 2104, the processing circuitry 302 controls the child device 300 to listen, via the receiver circuitry 316, to a second portion of the frequency band for a second amount of time. In some examples, the second amount of time has a duration that is based on a detection time of a second communication protocol.

In an example, the second portion of the frequency band corresponds to a second channel (e.g., associated with a second communication protocol, such as BLE) of the frequency band and the child device listens on the second channel for a preamble of an advertisement message, e.g., as described above with respect to FIG. 18. In some examples, the second portion of the frequency band corresponds to a frequency range belonging to second communication protocol, such as corresponding to the second channel associated with the second communication protocol, and the child device monitors for the presence of energy on the channel without loading PHY configuration data corresponding to the second communication protocol to the receiver circuitry, e.g., as described above with respect to FIG. 20. In some examples, the second communication protocol is different from the first communication protocol. For example, the first communication protocol may be Zigbee® or Thread®, and the second communication protocol may be BLE.

In the illustrated example of FIG. 21, responsive to not detecting, at operation 2106, communication on the second portion of the frequency band within the second period of time (e.g., when not detecting a preamble, e.g., of an advertisement packet; or not detecting energy in the second portion of the frequency band higher than a predetermined threshold), the processing circuitry 302 controls the child device 300 to return to operation 2102 to listen, via the receiver circuitry 316, to the first portion of the frequency band. In some examples, the processing circuitry 302 controls the receiver circuitry 316 to retune to a channel associated with the first communication protocol (e.g., such as the first portion or channel, or another channel associated with the first communication protocol) to listen for packets. In some examples, such as illustrated in FIG. 18, PHY configuration data associated with the first communication protocol is loaded into the receiver circuitry 316 when returning to block 2102 when not detecting communication on the second portion of the frequency band. In some examples, such as illustrated in FIG. 20, the loading of PHY configuration data associated with the first communication protocol may be omitted when returning to block 2102 when not detecting communication on the second portion of the frequency band (e.g., since the receiver circuitry may already have such PHY configuration data loaded).

In the illustrated example of FIG. 21, responsive to detecting, at operation 2106, communication on the second portion of the frequency band, at operation 2108 the processing circuitry 302 controls the child device 300 to receive one or more packets corresponding to the detected communication. In some examples, such as illustrated in FIG. 18, receiving the one or more packets includes continuing to listen to the second portion of the frequency band until the one or more packets have been received. In some examples, receiving the one or more packets includes listening to the second portion of the frequency band for a duration of time determined based on the second communication protocol, such as based on an advertisement packet duration according to the second communication protocol. In some examples, such as illustrated in FIG. 20, receiving the one or more packets includes listening to a third portion or channel of the frequency band associated with the second communication protocol for receiving a preamble and/or packet according to the second communication protocol. In some such examples, the communication may be initially detected based on energy detection being higher than a predetermined threshold, and then the detection may be confirmed once a preamble or advertisement packet is subsequently detected in another channel associated with the second communication protocol.

Based on the received packet(s), if any, after the initial detection in block 2106 and reception at operation 2108, the processing circuitry 302 may control the child device 300 to perform other actions, such as listening to a specified portion of the frequency band or channel for one or more data packets (e.g., using the second communication protocol), transmitting one or more packets (e.g., using the second communication protocol), processing one or more received packets (e.g., received using the second communication protocol), or the like, the scope of which is not limited herein. In some embodiments, after operation 2108 (and possibly other operations performed, e.g., based on the packets received during operation 2108), operation 2102 is performed again.

In some embodiments, method 2100 may be combined with other methods disclosed herein. For example, in some embodiments, when combining method 2000 with method 600 of FIG. 6, a method may include steps 602, 604, 606, 608, 610, 612, 614, and 616, e.g., as described with respect to FIG. 6, and then, from step 616, jump to step 2104, then perform step 2106 (and 2108, if applicable), and then returning to step 602.

As another example, when combining method 2000 with method 700, a method may include steps 702, 704, 706, 708, 710, 712, 716, 718, 720, 722, 724, and 726, e.g., as described with respect to FIG. 7, and then, from step 726, jump to step 2104, then perform step 2106 (and 2108, if applicable), and then returning to step 702.

Some embodiments, such as embodiments illustrated in FIGS. 18, 19, have been described with a periodic monitoring of the second communication protocol at fixed intervals. In some embodiments, the periodic monitoring of the second communication protocol may be performed dynamically such that the time allocation for the first and second communication protocols may change over time, e.g., based on network load, traffic type, and/or other characteristics of the network. For example, in some embodiments implemented in a similar manner as illustrated in FIG. 18, an initial allocation may operate about 9 ms in the first communication protocol and then about 1.2 ms on the second communication protocol. In response to changes in the network conditions, such as a decrease in traffic in the first communication protocol or an increase in interference associated with the first communication protocol, the allocation may change to, e.g., about 5 ms for operation according to the first protocol (e.g., changing m0 to about 5 ms) and about 5 ms for the second communication protocol (e.g., changing m2 to about 5 ms). The system may return to the original allocation, e.g., after a predetermined amount of time, or in response to additional changes to the network.

In some examples, a communication protocol may use multiple channels that may be allocated dynamically. For example, in some examples, as described above, channel hopping may be performed. In examples that allow for channel changes, such as in examples that implement channel hopping, the first and/or second channel described above with respect to time multiplexing may be selected from among a group of suitable channels, and references to the first or second (or other) channels (such as in FIGS. 3 and/or 18-21 and associated description) do not imply or require that the respective channel must always be the same channel. Rather, the first channel may be any one of a first group of suitable channels identified according to the first communication protocol as being suitable for channel hopping, and may change from time to time (e.g., at a first time, the first channel may be channel “w” and at a second time, the first channel may be channel “x”). Similarly, the second channel may be any one of a second group of suitable channels identified according to the second communication protocol as being suitable for channel hopping, and may change from time to time (e.g., at a first time, the first channel may be channel “y” and at a second time, the first channel may be channel “x”).

Example embodiments of the present disclosure are summarized here. Other embodiments can also be understood from the entirety of the specification and the claims filed herein.

Example 1. An device including: a receiver circuitry; and processing circuitry coupled to the receiver circuitry, the processing circuitry configured to: transition, at a first time, from monitoring a first channel via the receiver circuitry to monitoring a second channel via the receiver circuitry, where the first channel is associated with a first communication protocol and the second channel is associated with a second communication protocol, transition, at a second time, from monitoring the second channel via the receiver circuitry to monitoring the first channel via the receiver circuitry responsive to not detecting communication on the second channel, where an amount of time between the first time and the second time is based on a detection time for the second communication protocol.

Example 2. The device of example 1, where the first channel and the second channel are within a same frequency band.

Example 3. The device of one of examples 1 or 2, where the amount of time includes a transition time and a detection time.

Example 4. The device of one of examples 1 to 3, where the transition time is 400 microseconds.

Example 5. The device of one of examples 1 to 4, where the detection time is 1200 microseconds.

Example 6. The device of one of examples 1 to 5, where, responsive to detecting communication on the second channel during the detection time, the processing circuitry is configured to receive a first packet associated with the second communication protocol and including the communication.

Example 7. The device of one of examples 1 to 6, where the processing circuitry is configured to receive the first packet via a third channel via the receiver circuitry, where the third channel is associated with the second communication protocol.

Example 8. The device of one of examples 1 to 7, where detecting communication on the second channel includes detecting a preamble of a second packet associated with the second communication protocol during the detection time.

Example 9. The device of one of examples 1 to 8, where, after detecting the preamble of the second packet and responsive to receiving the second packet, the processing circuitry is configured to transition to monitoring the first channel via the receiver circuitry.

Example 10. The device of one of examples 1 to 9, where the processing circuitry is configured to: monitor the first channel for an average of eighty percent of a unit period of time; and monitor the second channel for an average of twenty percent of the unit period of time.

Example 11. The device of one of examples 1 to 10, where, responsive to detecting energy associated with the second channel and while the receiver circuitry is programmed with physical layer (PHY) configuration data corresponding to the first communication protocol, the processing circuitry is configured to transition, at a third time, from monitoring the second channel to monitoring a third channel via the receiver circuitry, where the third channel is associated with the second communication protocol.

Example 12. The device of one of examples 1 to 11, where to transition from monitoring the second channel to monitoring the third channel the processing circuitry is configured to program the receiver circuitry to program the receiver circuitry with PHY configuration data corresponding to the second communication protocol and retune a center frequency of the receiver circuitry to a center frequency corresponding to the third channel.

Example 13. The device of one of examples 1 to 12, where the receiver circuitry is configured to receive, on the third channel, a first packet associated with a second packet corresponding to the energy detected on the second channel.

Example 14. The device of one of examples 1 to 13, where the first packet is a replica of the second packet.

Example 15. The device of one of examples 1 to 14, where, after receiving the first packet and responsive to receiving a data packet via the second communication protocol, the processing circuitry is configured to transition to monitoring the first channel.

Example 16. The device of one of examples 1 to 15, where the processing circuitry is configured to detect energy associated with the second channel, via the receiver circuitry, without reprogramming the receiver circuitry with PHY configuration data corresponding to the second communication protocol.

Example 17. The device of one of examples 1 to 16, where to transition from the monitoring the first channel to monitoring the second channel, the processing circuitry is configured to control the receiver circuitry to tune a receiving frequency from a first frequency associated with the first channel to a second frequency associated with the second channel and to program the receiver circuitry with physical layer (PHY) configuration data corresponding to the second communication protocol.

Example 18. The device of one of examples 1 to 17, where to transition from the monitoring the second channel to monitoring the first channel, the processing circuitry is configured to control the receiver circuitry to tune the receiving frequency from the second frequency to the first frequency and to program the receiver circuitry with PHY configuration data corresponding to the first communication protocol.

Example 19. A method including: listening, via receiver circuitry, to a first portion of a frequency band for a first amount of time for communication via a first communication protocol; listening, via the receiver circuitry, to a second portion of the frequency band for a second amount of time, where the second amount of time has a duration that is based on a detection time of a second communication protocol, where the second communication protocol is different from the first communication protocol; and responsive to not detecting communication on the second portion of the frequency band within the second amount of time, listening, via the receiver circuitry, to the first portion of the frequency band for the first amount of time.

Example 20. The method of example 19, where the second communication protocol includes redundant transmissions over a series of portions of the frequency band, the method further including: detecting energy on the second portion of the frequency band; and responsive to detecting energy on the second portion of the frequency band, listening, via the receiver circuitry, to a third portion of the frequency band, where the third portion is associated with the second communication protocol.

Example 21. The method of one of examples 19 or 20, where the series of portions are consecutive channels.

Example 22. The method of one of examples 19 to 21, where the second communication protocol is a Bluetooth® Low Energy (BLE) protocol, and where the series of portions includes channels 37, 38, and 39, according to the BLE protocol.

Example 23. The method of one of examples 19 to 22, where the first portion of the frequency band corresponds to channel 37 according to the BLE protocol, and where the third portion is channel 39 according to the BLE protocol.

Example 24. The method of one of examples 19 to 23, where the duration of the second amount of time is between 400 microseconds and 500 microseconds.

Example 25. The method of one of examples 19 to 24, where the second portion of the frequency band corresponds to a fourth portion associated with the second communication protocol, the fourth portion being different from the third portion.

Example 26. The method of one of examples 19 to 25, where the third portion is an advertisement channel.

Example 27. The method of one of examples 19 to 26, further including: receiving, via the receiver circuitry, a first packet associated with the second communication protocol; and after receiving the first packet, listening, via the receiver circuitry, to the first portion for the first amount of time.

Example 28. The method of one of examples 19 to 27, further including, responsive to detecting communication on the second portion of the frequency band within the second amount of time, listening, via the receiver circuitry, to a third channel associated with the second communication protocol.

Example 29. The method of one of examples 19 to 28, further including, responsive to receiving a first packet associated with the second communication protocol, listening, via the receiver circuitry, to the first portion for the first amount of time.

Example 30. The method of one of examples 19 to 29, where detecting communication on the second portion of the frequency band includes detecting a preamble according to the second communication protocol.

Example 31. The method of one of examples 19 to 30, further including periodically alternating between listening to the first portion for the first amount of time and listening to the second portion of the frequency band for the second amount of time.

Example 32. The method of one of examples 19 to 31, where, in an absence of communication on the second portion of the frequency band, the receiver circuitry listens to the second portion of the frequency band for no greater than thirty percent of a unit period of time.

Example 33. The method of one of examples 19 to 32, where, in an absence of communication on the second portion of the frequency band, the receiver circuitry listens to the second portion of the frequency band for 1200 microseconds of each 10 millisecond period of time.

Example 34. The method of one of examples 19 to 33, where a transition time between the receiver circuitry listening to the first portion and the receiver circuitry listening to the second portion of the frequency band is 400 microseconds.

Example 35. The method of one of examples 19 to 34, where the first communication protocol is an Institute of Electrical and Electronics Engineers (IEEE) 802.15.4 based communication protocol and the second communication protocol is a Bluetooth® Low Energy (BLE) protocol.

Example 36. The method of one of examples 19 to 35, where the first communication protocol is Zigbee® or Thread®, and the second communication protocol is Bluetooth® Low Energy (BLE).

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that enable channel hopping across difference frequency bands. Additionally, example systems, apparatus, articles of manufacture, and methods described herein reduce the computational overhead utilized to synchronize devices in a network. For example, example child devices described herein track synchronization information of parent devices and example parent devices do not track synchronization information of other devices. Examples described herein also enable channel hopping on CSL capable devices. Described systems, apparatus, articles of manufacture, and methods improve the efficiency of using a computing device by improving connectivity strength between parent devices and child devices. For example, described systems, apparatus, articles of manufacture, and methods improve the efficiency of using a computing device by supporting better parent selection and lower synchronization overhead. Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An device comprising:
a receiver circuitry; and
processing circuitry coupled to the receiver circuitry, the processing circuitry configured to:
transition, at a first time, from monitoring a first channel via the receiver circuitry to monitoring a second channel via the receiver circuitry, wherein the first channel is associated with a first communication protocol and the second channel is associated with a second communication protocol; and
transition, at a second time, from monitoring the second channel via the receiver circuitry to monitoring the first channel via the receiver circuitry responsive to not detecting communication on the second channel, wherein an amount of time between the first time and the second time is based on a detection time for the second communication protocol.

2. The device of claim 1, wherein the first channel and the second channel are within a same frequency band.

3. The device of claim 1, wherein the amount of time includes a transition time and a detection time.

4. The device of claim 3, wherein, responsive to detecting communication on the second channel during the detection time, the processing circuitry is configured to receive a first packet associated with the second communication protocol and including the communication.

5. The device of claim 4, wherein the processing circuitry is configured to receive the first packet via a third channel via the receiver circuitry, wherein the third channel is associated with the second communication protocol.

6. The device of claim 4, wherein detecting communication on the second channel comprises detecting a preamble of a second packet associated with the second communication protocol during the detection time.

7. The device of claim 6, wherein, after detecting the preamble of the second packet and responsive to receiving the second packet, the processing circuitry is configured to transition to monitoring the first channel via the receiver circuitry.

8. The device of claim 1, wherein the processing circuitry is configured to:
monitor the first channel for an average of eighty percent of a unit period of time; and
monitor the second channel for an average of twenty percent of the unit period of time.

9. The device of claim 1, wherein, responsive to detecting energy associated with the second channel and while the receiver circuitry is programmed with physical layer (PHY) configuration data corresponding to the first communication protocol, the processing circuitry is configured to transition, at a third time, from monitoring the second channel to monitoring a third channel via the receiver circuitry, wherein the third channel is associated with the second communication protocol.

10. The device of claim 9, wherein to transition from monitoring the second channel to monitoring the third channel the processing circuitry is configured to program the receiver circuitry to program the receiver circuitry with PHY configuration data corresponding to the second communication protocol and retune a center frequency of the receiver circuitry to a center frequency corresponding to the third channel.

11. The device of claim 9, wherein the receiver circuitry is configured to receive, on the third channel, a first packet associated with a second packet corresponding to the energy detected on the second channel.

12. The device of claim 11, wherein the first packet is a replica of the second packet.

13. The device of claim 11, wherein, after receiving the first packet and responsive to receiving a data packet via the second communication protocol, the processing circuitry is configured to transition to monitoring the first channel.

14. The device of claim 9, wherein the processing circuitry is configured to detect energy associated with the second channel, via the receiver circuitry, without reprogramming the receiver circuitry with PHY configuration data corresponding to the second communication protocol.

15. The device of claim 1, wherein to transition from the monitoring the first channel to monitoring the second channel, the processing circuitry is configured to control the receiver circuitry to tune a receiving frequency from a first frequency associated with the first channel to a second frequency associated with the second channel and to program the receiver circuitry with physical layer (PHY) configuration data corresponding to the second communication protocol.

16. The device of claim 15, wherein to transition from the monitoring the second channel to monitoring the first channel, the processing circuitry is configured to control the receiver circuitry to tune the receiving frequency from the second frequency to the first frequency and to program the receiver circuitry with PHY configuration data corresponding to the first communication protocol.

17. A method comprising:
listening, via receiver circuitry, to a first portion of a frequency band for a first amount of time for communication via a first communication protocol;
listening, via the receiver circuitry, to a second portion of the frequency band for a second amount of time, wherein the second amount of time has a duration that is based on a detection time of a second communication protocol, wherein the second communication protocol is different from the first communication protocol; and
responsive to not detecting communication on the second portion of the frequency band within the second amount of time, listening, via the receiver circuitry, to the first portion of the frequency band for the first amount of time.

18. The method of claim 17, wherein the second communication protocol includes redundant transmissions over a series of portions of the frequency band, the method further comprising:
detecting energy on the second portion of the frequency band; and
responsive to detecting energy on the second portion of the frequency band, listening, via the receiver circuitry, to a third portion of the frequency band, wherein the third portion is associated with the second communication protocol.

19. The method of claim 18, wherein the second communication protocol is a Bluetooth® Low Energy (BLE) protocol, and wherein the series of portions comprises channels 37, 38, and 39, according to the BLE protocol.

20. The method of claim 19, wherein the first portion of the frequency band corresponds to channel 37 according to the BLE protocol, and wherein the third portion is channel 39 according to the BLE protocol.

21. The method of claim 18, further comprising:
receiving, via the receiver circuitry, a first packet associated with the second communication protocol; and
after receiving the first packet, listening, via the receiver circuitry, to the first portion for the first amount of time.

22. The method of claim 17, further comprising, responsive to detecting communication on the second portion of the frequency band within the second amount of time, listening, via the receiver circuitry, to a third channel associated with the second communication protocol.

23. The method of claim 22, further comprising, responsive to receiving a first packet associated with the second communication protocol, listening, via the receiver circuitry, to the first portion for the first amount of time.

24. The method of claim 22, wherein detecting communication on the second portion of the frequency band comprises detecting a preamble according to the second communication protocol.

25. The method of claim 17, further comprising periodically alternating between listening to the first portion for the first amount of time and listening to the second portion of the frequency band for the second amount of time.

26. The method of claim 17, wherein the first communication protocol is an Institute of Electrical and Electronics Engineers (IEEE) 802.15.4 based communication protocol and the second communication protocol is a Bluetooth® Low Energy (BLE) protocol.
